(19) United States
(12) Patent Application Publication
(10) Pub. No.: US 2026/0261990 A1
(43) Pub. Date: Sep. 3, 2026

(54) MULTI-PERIODICITY SYNCHRONIZATION SIGNALING

(71) Applicant: QUALCOMM Incorporated, San Diego, CA (US)

(72) Inventors: Xiaoxia ZHANG, San Diego, CA (US); Tao LUO, San Diego, CA (US); Navid ABEDINI, Basking Ridge, NJ (US); Sony AKKARAKARAN, Poway, CA (US); Igor GUTMAN, Hod HaSharon, Haifa District (IL); Narayan PRASAD, Westfield, NJ (US); Junyi LI, Greentown, PA (US)

(21) Appl. No.: 19/066,970

(22) Filed: Feb. 28, 2025

(51) Int. Cl. H04W 56/00

(52) U.S. Cl. CPC H04W 56/001

(57) ABSTRACT

Certain aspects of the present disclosure provide techniques for communication of multi-periodicity synchronization signaling. An example method includes obtaining signaling that includes an indication of a plurality of transmission occasions associated with synchronization signaling, wherein: the synchronization signaling includes a first set of synchronization signals and a second set of synchronization signals, and the indication of the plurality of transmission occasions indicates that the first set of synchronization signals is arranged in time with a first periodicity and indicates that the second set of synchronization signals is arranged in time with a second periodicity different from the first periodicity; obtaining at least one synchronization signal of the synchronization signaling in at least one transmission occasion of the plurality of transmission occasions; and communicating based at least in part on the at least one synchronization signal.

### INTRODUCTION

### Field of the Disclosure

Aspects of the present disclosure relate to wireless communications, and more particularly, to techniques for communication of synchronization signaling.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Certain aspects provide a method for wireless communications by a user equipment (UE). The method includes obtaining signaling that includes an indication of a plurality of transmission occasions associated with synchronization signaling, wherein: the synchronization signaling includes a first set of synchronization signals and a second set of synchronization signals, and the indication of the plurality of transmission occasions indicates that the first set of synchronization signals is arranged in time with a first periodicity and indicates that the second set of synchronization signals is arranged in time with a second periodicity different from the first periodicity; obtaining at least one synchronization signal of the synchronization signaling in at least one transmission occasion of the plurality of transmission occasions; and communicating based at least in part on the at least one synchronization signal.

Certain aspects provide a method for wireless communications by a network node. The method includes sending signaling that includes an indication of a plurality of transmission occasions associated with synchronization signaling, wherein: the synchronization signaling includes a first set of synchronization signals and a second set of synchronization signals, and the indication of the plurality of transmission occasions indicates that the first set of synchronization signals is arranged in time with a first periodicity and indicates that the second set of synchronization signals is arranged in time with a second periodicity different from the first periodicity; sending at least one synchronization signal of the synchronization signaling in at least one transmission occasion of the plurality of transmission occasions; and communicating based at least in part on the at least one synchronization signal.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5A depicts a process flow diagram of an example four-step random access procedure.

FIG. 5B depicts a process flow diagram of an example two-step random access procedure.

FIG. 6 depicts an example of beam prediction by a UE.

FIG. 7 depicts an example scheme for communication of multi-periodicity synchronization signaling.

FIG. 8 depicts an example scheme for mapping random access occasions to synchronization signals.

FIG. 9 depicts a process flow for multi-periodicity synchronization signaling.

FIG. 10 depicts a method for wireless communications.

FIG. 11 depicts another method for wireless communications.

FIG. 12 depicts aspects of an example communications device.

FIG. 13 depicts aspects of an example communications device.

### DETAILED DESCRIPTION

Aspects of the present disclosure provide apparatuses, methods, processing systems, and computer-readable mediums for communication of multi-periodicity synchronization signaling. The term “beam” may be used in the present disclosure in various contexts. Beam may be used to mean a set of gains and/or phases (e.g., precoding weights or co-phasing weights) applied to antenna elements in (or associated with) a wireless communication device for transmission or reception. The term “beam” may also refer to an antenna or radiation pattern of a signal transmitted while applying the gains and/or phases to the antenna elements. Other references to beam may include one or more properties or parameters associated with the antenna (or radiation) pattern, such as an angle of arrival (AoA), an angle of departure (AoD), a gain, a phase, a directivity, a beam width, a beam direction (with respect to a plane of reference) in terms of azimuth and/or elevation, a peak-to-side-lobe ratio, and/or an antenna (or precoding) port associated with the antenna (radiation) pattern. The term “beam” may also refer to an associated number and/or configuration of antenna elements (e.g., a uniform linear array, a uniform rectangular array, or other uniform array).

Certain wireless communication systems (e.g., a 5G NR system and/or any other suitable wireless communication system) may use beamforming for directional signal transmission and/or reception to facilitate efficient and reliable wireless communications. As an example, beamforming may apply various amplitude weighting and/or phase shift patterns across multiple antennas to focus transmission or reception of wireless signals in a particular spatial direction (e.g., azimuth and/or elevation) and/or beamwidth generally defining a beam. In particular, efficient and reliable communications may be achieved through various beam management techniques such as beamforming, beam selection (e.g., the process of selecting a beam to use for wireless communications), beam failure detection procedure(s) (e.g., the process of detecting when communications via a beam do not meet a quality or reliability specification, such as a particular data error rate), beam failure recovery procedure(s) (e.g., the process of selecting an alternative beam when beam failure is detected for a particular beam used for communications), or the like. Such beam management techniques may be critical to achieving the high data rates, low latency, and/or high reliability that various generations of wireless technologies promise to deliver.

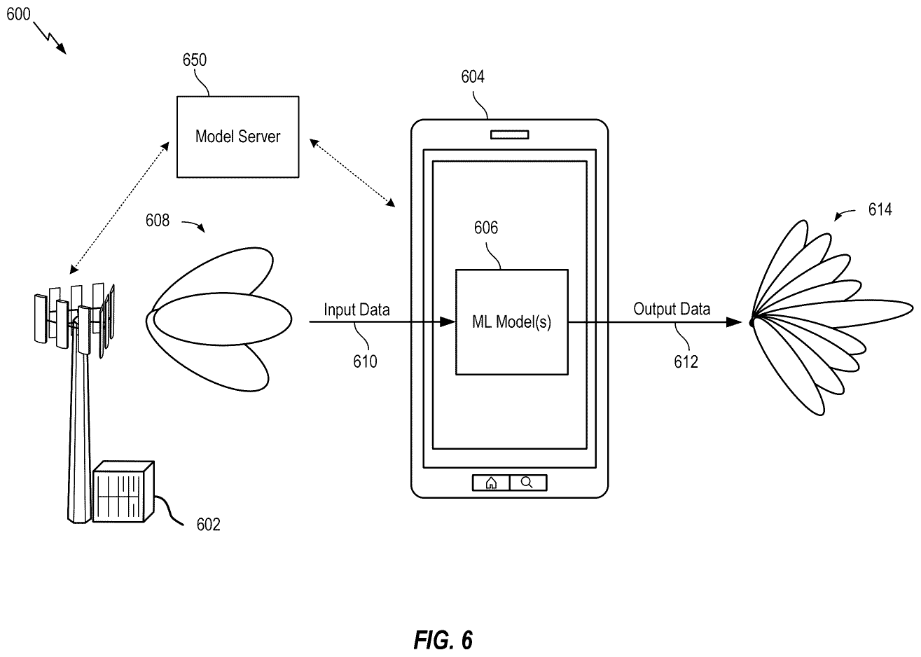

In certain cases, beam management may be enabled through certain prediction techniques including artificial intelligence (AI)-based beam predictions, such as spectral beam predictions, temporal beam predictions, and/or spatial beam predictions, for example, as further described herein with respect to FIG. 6. As used herein, AI-based beam prediction may refer to beam prediction(s) derived from one or more AI models and/or one or more machine learning (ML) models. As an example, a wireless communication device (such as a user equipment (UE) and/or a network node) may use an ML model to form certain beam predictions for a set of A beams (such as temporal and/or spatial beam predictions) based on measurement results of a set of B beams. The set of A beams may be referred to as “Set-A beams,” and the set of B beams may be referred to as “Set-B beams.” For example, a UE may monitor reference signals associated with the Set-B beams, such as synchronization signalling (e.g., synchronization signal block (SSB) transmissions), channel state information reference signals (CSI-RSs), demodulation reference signals DMRSs, or the like. Then, the UE may provide measurements of the reference signals associated with the Set-B beams to the ML model; and the UE may obtain predictions associated with the Set-A beams from the ML model based on the measurements of the reference signals associated with the Set-B beams.

Technical problems for wireless communications may include, for example, effective energy consumption and/or channel usage for communication of synchronization signaling. To enable initial cell access and maintain communications with a UE (e.g., through time and frequency synchronization), a network node (e.g., a base station and/or a disaggregated network entity thereof) periodically broadcasts certain signaling, such as synchronization signals, regardless of whether any UEs are currently communicating or expected to communicate with the network node. As an example, during an SSB burst (e.g., a sequence of SSBs communicated in a periodic cycle), the network node may perform a transmit beam sweep via SSBs, for example, by sending one or more SSBs per transmit beam of the network node. Such a beam sweep may enable a UE to identify suitable transmit beam(s) for communications between the UE and the network node. In certain cases, the synchronization signaling may enable a UE to determine the propagation delay between the network node and the UE for time synchronization as well as certain frequency pre-compensations (e.g., Doppler shift compensations). The SSB burst may be broadcast with a specific periodicity, for example, every 5 milliseconds (ms) to 160 ms. Thus, communication of certain synchronization signaling consumes a non-trivial amount of energy at wireless communications device (such as a network node and/or a UE) and/or a non-trivial amount of communication resources in terms of channel usage.

Aspects described herein may overcome the aforementioned technical problem(s), for example, by providing certain scheme(s) that enable communication of synchronization signaling with multiple periodicities, which may enable reduced power consumption and/or effective channel usage, as further described herein. In certain aspects, synchronization signaling may be partitioned into multiple sets, such as sets associated with the Set-A beams and the Set-B beams, respectively, used for AI-based wireless communications. Though Set-A beams and Set-B beams are used as example sets, the techniques discussed herein may be applicable to other multiple sets. A first set of synchronization signals associated with Set-B beams (e.g., some of the SSBs in an SSB burst) may be communicated with a different periodicity than a second set of synchronization signals associated with Set-A beams (e.g., the remaining SSBs in an SSB burst). As an example, the first set of synchronization signals associated with Set-B beams may be communicated more frequently than the second set of synchronization signals associated with Set-A beams. As further described herein, the scheme(s) may enable communication of wakeup signaling for on-demand synchronization signaling associated with the Set-A beams and/or the Set-B beams. The scheme(s) described herein may enable the mapping of random access occasions amongst the sets of synchronization signaling associated with Set-A beams and/or Set-Beams. The scheme(s) described herein may enable measurement of the sets of synchronization signaling associated with Set-A beams and/or Set-Beams for radio resource management and/or the like.

Certain techniques for communication of multi-periodicity synchronization signaling described herein may provide various beneficial technical effects and/or advantages. The techniques for communication of multi-periodicity synchronization signaling may enable improved wireless communications performance, such as reduced energy consumption, effective channel usage, and/or the like. The reduced power consumption at a network node and/or UE may be attributable to the reduction in transmission and/or measurement of synchronization signaling associated with (e.g., the Set-A) beams, for example, due to the prediction of characteristics associated with the Set-A beams enabled through AI-based beam prediction. As an example, a network node may transmit synchronization signaling associated with the Set-A beams with a greater periodicity (e.g., lower frequency) relative to the periodicity used for communication of synchronization signaling associated with the Set-B beams. Thus, the network node may reduce the overall transmissions of synchronization signaling, which in turn may result in a reduction in power consumed by or at the network node.

As another example, a UE may refrain from measuring or monitoring for synchronization signaling associated with the Set-A beams, for example, due to the UE being able to determine, estimate, or predict characteristic(s) associated with the Set-A beams based on measurements of synchronization signaling associated with the Set-B beams. Thus, the UE may reduce the overall power consumed to measure synchronization signaling, which in turn may result in a reduction in power consumed by or at the UE.

In certain cases, the effective channel usage may be attributable to the reduction in transmission of synchronization signaling associated with the Set-A beams at or by a network node. As an example, a network node may transmit synchronization signaling associated with the Set-A beams with a greater periodicity relative to the periodicity used for communication of synchronization signaling associated with the Set-B beams. Thus, the network node may be able to reallocate communication resources (e.g., time, frequency, and/or spatial resources), which hypothetically would be used to communicate synchronization signaling associated with the Set-A beams with a shorter periodicity, for other communications including, for example, data, control, downlink, and/or uplink communications. Accordingly, the communication of multi-periodicity synchronization signaling may enable effective channel usage for various communications.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

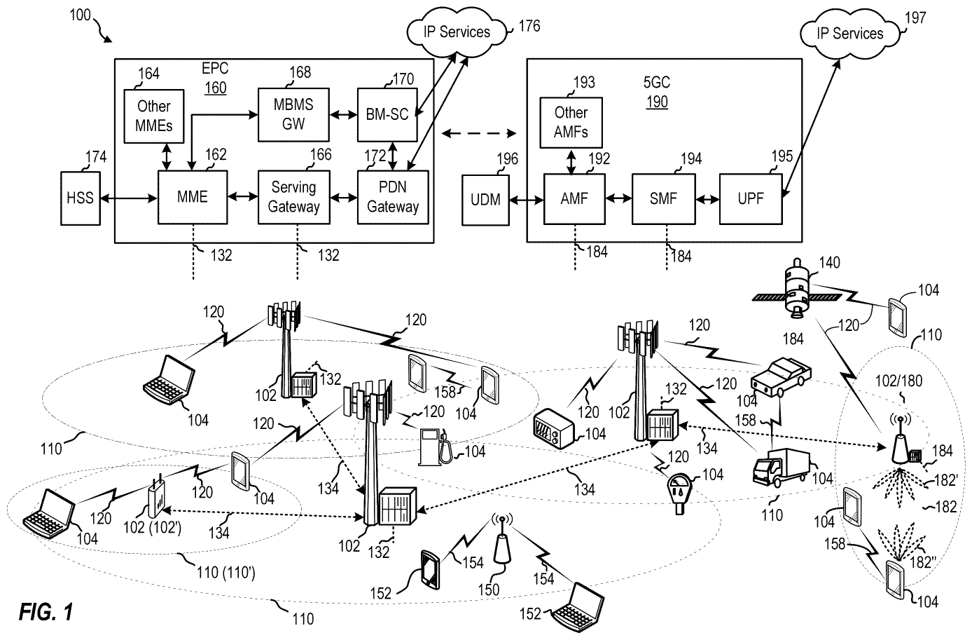

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IOT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

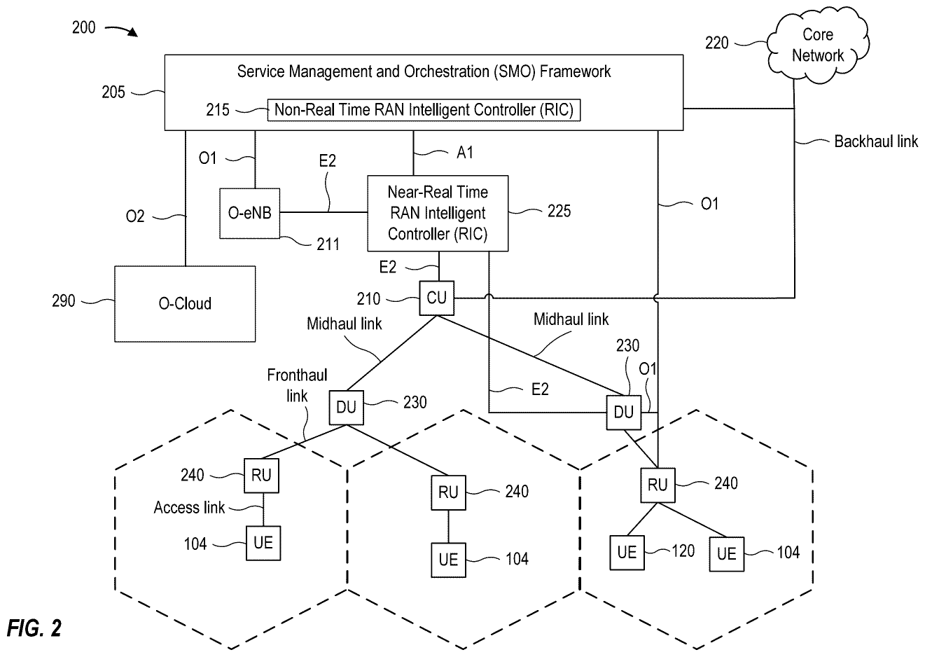

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHZ, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QOS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an 02 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

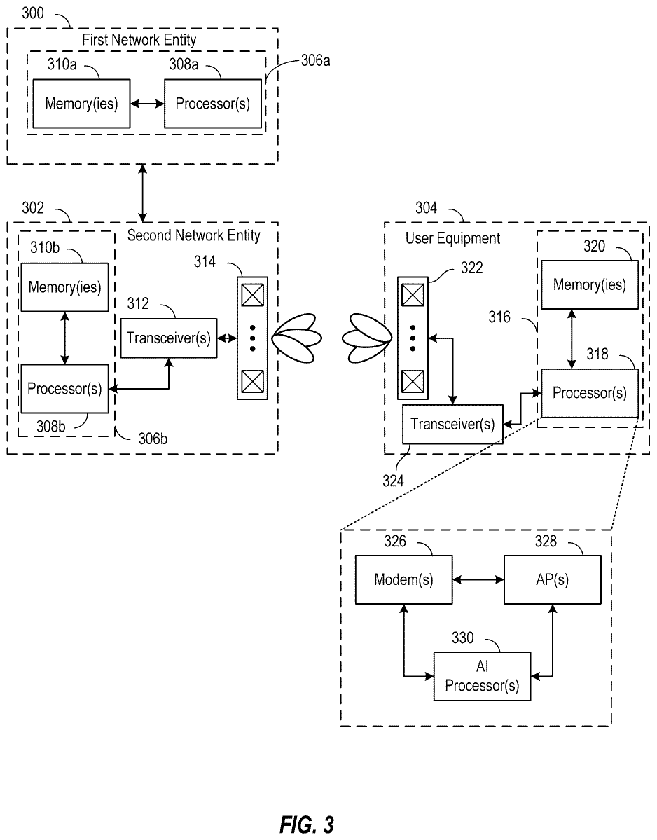

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

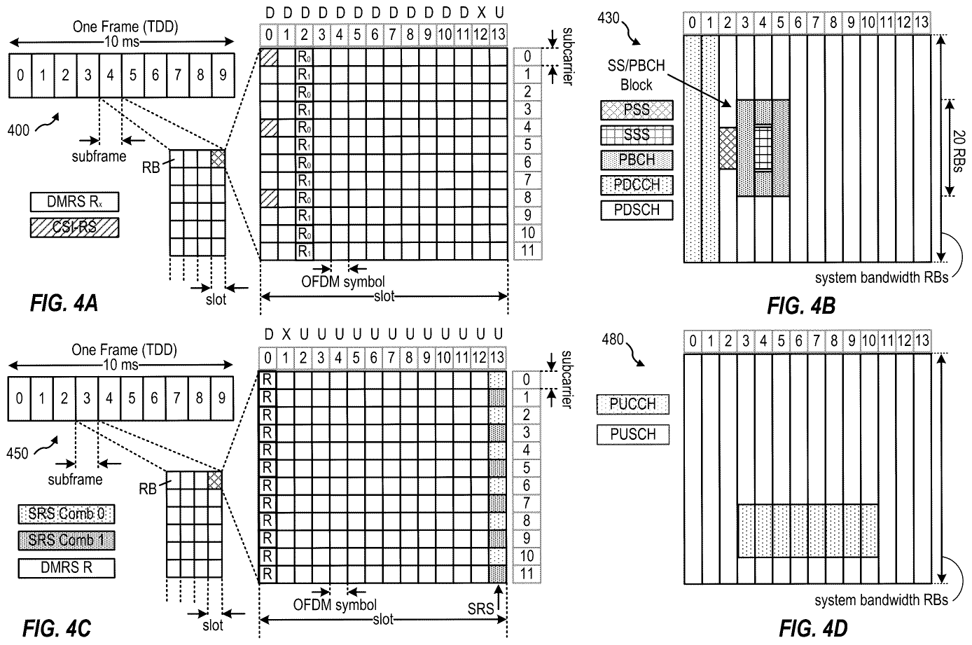

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology u, there are 24 slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2″× 15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example Random Access Procedures

Certain wireless communication systems (e.g., a 5G NR system and/or any suitable wireless communications system) may provide a specified channel for random access, such as a random access channel (RACH), and corresponding random access procedure(s). A random access procedure may be performed for any of various events including, for example, initial access from an idle state (e.g., RRC idle), RRC connection re-establishment, handover, downlink (DL) and/or uplink (UL) data arrival (e.g., when the UE is in an idle state), or device positioning.

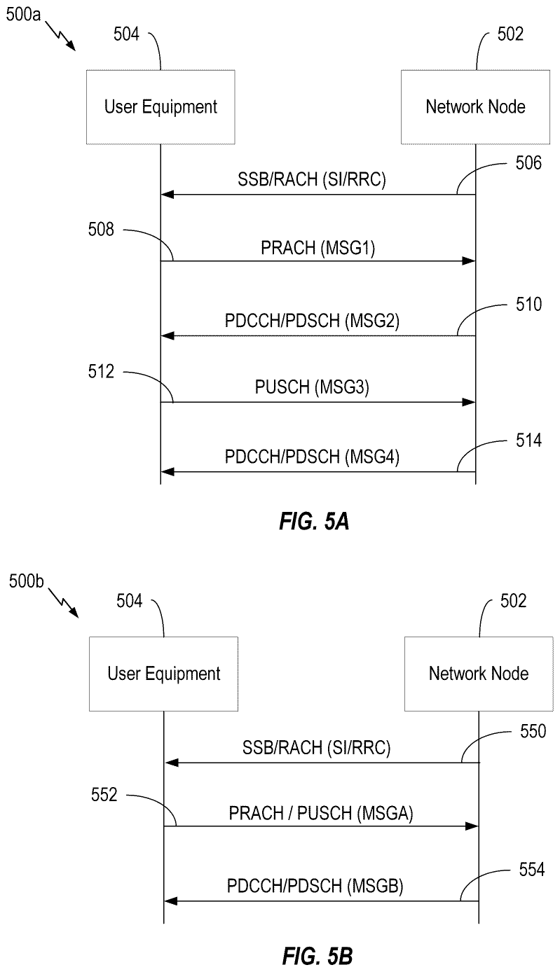

FIG. 5A depicts a process flow diagram of an example four-step RACH procedure 500a performed between a UE 504 and a network node 502. In some aspects, the UE 504 is the UE 104 depicted and described with respect to FIGS. 1 and 3, and the network node 502 is the base station 102 depicted and described with respect to FIGS. 1 and 3 or a disaggregated base station depicted and described with respect to FIG. 2.

The RACH procedure 500a may optionally begin at 506, where the network node 502 broadcasts and the UE 504 receives a random access configuration, for example, in system information (SI) within a synchronization signal block (SSB), or within an RRC message. The random access configuration may indicate or include one or more parameters for random access communications, such as defining the RACH (e.g., in terms of time-frequency resource allocation), the total number of random access preambles (e.g., preamble sequences) available for random access, power ramping parameters, response window size (duration), etc.

At 508, the UE 504 sends a first message (MSG1) to the network node 502 on a physical random access channel (PRACH). In some cases, a PRACH may be referred to as a RACH. In certain aspects, MSG1 may indicate or include a RACH preamble. The RACH preamble may be or include a preamble sequence (e.g., a Zaddoff Chu sequence). For contention-based random access, the preamble sequence may be randomly selected among a set of preamble sequences (e.g., up to 64 sequences, in some cases). The preamble sequence may be used to identify the UE 504 for scheduling communications (e.g., MSG2 and MSG3) with the network node. In certain aspects, terms such as “RACH preamble,” “random access preamble,” “preamble,” “preamble sequence,” “sequence,” and the like may be used interchangeably.

At 510, the network node 502 may respond with a random access response (RAR) message (MSG2). For example, the network node 502 may send a PDCCH communication including downlink control information (DCI) that schedules the RAR on the PDSCH. The RAR may include, for example, certain parameters used for an uplink transmission such as a random access (RA) preamble identifier (RAPID), a timing advance, an uplink (UL) grant (e.g., indicating one or more time-frequency resources for an uplink transmission), cell radio network temporary identifier (C-RNTI), and/or a backoff parameter value. The RAPID may correspond to the preamble sequence and indicate that the RAR is for the UE 504 that transmitted MSG1 at 506. The backoff parameter value may be used to determine a RACH occasion (RO) for sending a subsequent RACH transmission (e.g., a preamble transmission). A RACH occasion may correspond to one or more time-frequency resources available for transmitting a preamble in a RACH.

At 512, in response to MSG2, the UE 504 transmits a third message (MSG3) to the network node 502 on the PUSCH. In some aspects, MSG3 may include an RRC connection request, a tracking area update (e.g., for UE mobility), and/or a scheduling request (for an UL transmission). As an example, MSG3 is communicated in the time-frequency resource(s) indicated in the UL grant of the RAR.

At 514, the network node 502 may send a contention resolution message (MSG4) in response to MSG3. The network node 502 may send a downlink scheduling command (e.g., DCI), which is addressed to a specific UE identity associated with the UE 504 as discussed below, via the PDCCH. The network node 502 may send a UE contention resolution identity (e.g., a medium access control element) via the PDSCH according to the downlink scheduling command. In certain cases, multiple UEs may send the same preamble in the same RO. As the network node 502 may not be able to identify which UE sent which preamble, the network node 502 may reply with a single RAR associated with the preamble. The MSG3 may include or indicate a specific UE identity associated with the UE 504, such as a radio network temporary identifier (RNTI) or a temporary mobile subscriber identity (TMSI). The network node 502 may decode MSG3 and determine the UE identity associated with at least one of the UEs (e.g., UE 504). MSG4 may be addressed to the UE identity (e.g., the RNTI or an RNTI based on the TMSI) associated with the MSG3 that the network node was able to successfully decode. For example, the MSG4 may be scrambled by the RNTI associated with the MSG3. If the UE 504 obtains the same identity sent in MSG3, the UE 504 concludes that the random access procedure succeeded. In some cases, if the UE 504 is unable to obtain or decode MSG3 and/or MSG4, the UE 504 may repeat the RACH procedure, such as the four-step RACH procedure 500a.

In some cases, to reduce the latency associated with random access, a two-step RACH procedure may be used. As the name implies, the two-step RACH procedure may effectively consolidate the four messages of the four-step RACH procedure into two messages.

FIG. 5B depicts a process flow diagram of an example two-step RACH procedure 500b performed between the UE 504 and the network node 502.

The procedure 500b may optionally begin at 550, where the network node 502 broadcasts and the UE 504 receives a random access configuration, for example in system information within a synchronization signal block, or within an RRC message.

At 552, the UE 504 sends a first message (MSGA) to the network node 502, which may effectively combine MSG1 and MSG3 described above with respect to FIG. 5A. In some aspects, MSGA includes a RACH preamble for random access and a payload. For example, the payload may include a UE-ID and other signaling information, such as a buffer status report or scheduling request. The RACH preamble of MSGA may be transmitted over the PRACH, and the payload of MSGA may be transmitted over the PUSCH, for example.

At 554, the network node 502 may send a random access response message (MSGB), which may effectively combine MSG2 and MSG4 described above, via the PDCCH and PDSCH. For example, MSGB may include a RAPID, a timing advance, a backoff parameter value, a contention resolution message, an uplink and/or downlink grant, and transmit power control commands.

### Aspects Related to Artificial Intelligence-Aided Beam Management Procedures

Certain aspects described herein may be implemented, at least in part, using some form of AI, e.g., the process of using a ML model to infer or predict output data based on input data. An example ML model may include a mathematical representation of one or more relationships among various objects to provide an output representing one or more predictions or inferences. Once an ML model has been trained, the ML model may be deployed to process data that may be similar to, or associated with, all or part of the training data and provide an output representing one or more predictions or inferences based on the input data.

Aspects of the present disclosure may describe the performance of certain tasks and the technical solution of various technical problems by application of a specific type of ML model, such as an artificial neural network (ANN). It should be understood, however, that other type(s) of AI models may be used in addition to or instead of an ANN. An ML model may be an example of an AI model, and any suitable AI model may be used in addition to or instead of any of the ML models described herein. Hence, unless expressly recited, subject matter regarding an ML model is not necessarily intended to be limited to just an ANN solution or machine learning. Further, it should be understood that terms such as “AI model,” “ML model,” “AI/ML model,” “trained ML model,” and the like may be interchangeable.

AI/ML techniques have been introduced to help reduce the complexity involved in beam selection and the overhead associated with beam management without sacrificing system performance. For example, with the help of ML techniques, beam selection may be performed in a fraction of the time taken by conventional exhaustive search methods and with performance comparable to that of such methods.

In certain aspects, an ML model is deployed at or on a UE (e.g., such as UE 104 in FIG. 1), for example, for purposes of spatial domain (SD), temporal domain (TD), and/or frequency domain (FD) beam prediction. The TD refers to the analytic space in which signals are conveyed in terms of time. The FD refers to the analytic space in which signals are conveyed in terms of frequency. A scenario where the ML model, at or on the UE, is used to predict SD downlink beams for the Set-A beams based on measurement results of the Set-B beams may be referred to as a beam management case 1, or simply “BM-Case1.” Additionally, a scenario where the ML model, at or on the UE, is used to predict TD downlink beams for Set-A beams based on the historic measurement results of Set-B beams may be referred to as a beam management case 2, or simply “BM-Case2.” In general, ML may be used to predict characteristics associated with the Set-A beams, and the Set-B beams may be used for DL beam measurements as input data for the ML. For BM-Case1 and BM-Case2, the beams in the Set-A beams and the Set-B beams may be in the same Frequency Range (e.g., FR1 and/or FR2). In some cases, the Set-B beams may be a subset of the Set-A beams. For example, the Set-A beams may include a set of narrow beams, and the Set-B beams may be a subset of the narrow beams. There may be any number of beams in each of the Set-A beams and the Set-B beams. There may be quasi-colocation (QCL) relationships between the Set-A beams and the Set-B beams.

FIG. 6 is a diagram illustrating example beam prediction 600 by a UE. In this example, one or more ML models (hereinafter “the ML model 606”) are deployed at or on the UE 604 to enable the UE 604 to determine one or more beam predictions based on data input to ML model 606. The UE 604 may be an example of UE 104 depicted and described with respect to FIG. 1 or the UE 304 depicted and described with respect to FIG. 3.

A network node 602 (e.g., a base station or any disaggregated entity thereof) may transmit one or more signals (e.g., SSB(s), DM-RS(s), CSI-RS(s)), via a first set of transmit beams 608, in a first set of communication resources (e.g., an SSB resource, a DM-RS resource, and/or a CSI-RS resource). The network node 602 may be an example of the BS 102 depicted and described with respect to FIG. 1, the first network entity 300 or the second network entity 302 depicted and described with respect to FIG. 3, or a disaggregated base station depicted and described with respect to FIG. 2.

The UE 604 may perform measurements (e.g., Layer-1 reference signal received power (L1-RSRP) measurements and/or other measurements) of the one or more signals transmitted in the first set of communication resources, or a subset thereof, to obtain input data, which may include a first set of measurements 610 (sometimes referred to as parameters, channel characteristics, or channel properties). For example, each transmit beam 608 (or a subset thereof), from the first set of beams 608 carrying the signal(s), may be associated with one or more measurements 610 performed by UE 604. The UE 604 may feed the first set of measurements 610 (e.g., L1-RSRP measurement values) into the ML model 606. The UE 604 may further feed information associated with the first set of beams and/or first set of communication resources (or a subset thereof). The information associated with the first set of beams may include a beam direction (e.g., a spatial direction), beam width, beam shape, and/or other characteristics of the respective beam.

The ML model 606 may provide output data, for example, including an indication of a second set of measurements 612. As part of AI-based beam prediction, the second set of measurements 612 may include one or more predicted measurement values for a second set of communication resources associated with a second set of transmit beams 614. As an example, the second set of measurements 612 may include one or more predicted channel characteristics (e.g., predicted L1-RSRP measurement values) associated with the second set of communication resources, where the second set of communication resources are associated with the second set of transmit beams 614. In certain cases, the UE 604 may perform measurements of one or more signals transmitted in the second set of communication resources, or a subset thereof, to obtain the second set of measurements 612, for example, as a part of training data collection and/or performance monitoring for the ML model 606.

In some examples, the first set of beams 608 (e.g., that are measured) may be referred to as “Set-B beams” and the second set of beams 614 (e.g., that are associated with predicted measurements for the second set of communication resources) may be referred to as “Set-A beams.” Put another way, the “Set-B beams” are a set of beams for which measurements are taken and used to determine input data based on such measurements for the ML model 606, whereas the “Set-A beams” are a set of beams for which ML model 606 performs predictions.

In some examples, the first set of beams 608 are a subset of the second set of beams 614. In some other examples, the first set of beams 608 and the second set of beams 614 are different beams and/or may be mutually exclusive sets. For example, the first set of beams 608 may include wide beams (e.g., unrefined beams or beams having a beam width that satisfies a first threshold), and the second set of beams 614 may include narrow beams (e.g., refined beams or beams having a beam width that satisfies a second threshold).

Use of the ML model 606 for beam prediction may reduce a quantity of beam measurements that are performed by the UE 604 (e.g., compared to certain exhaustive beam searching methods that may involve obtaining measurements associated with all of the transmit beams associated with the network node 602), thereby conserving power at the UE 604 and/or network resources that would have otherwise been used to measure all beams included in at least the first set of beams 608.

In some aspects, this type of prediction may be referred to as a codebook-based SD selection or prediction. The codebook-based SD prediction/selection may be associated with an initial access, a secondary cell group (SCG) setup, a serving beam refinement, and/or a link quality (e.g., channel quality indicator (CQI) or precoding matrix indicator (PMI)) and interference adaptation.

As another example, an output of the ML model 606 may include a point-direction, an angle of departure (AoD), and/or an angle of arrival (AoA) of a beam included in the second set of beams 614 (e.g., the “Set-A beams”). This type of prediction may be referred to as a non-codebook-based SD selection or prediction. The non-codebook-based prediction/selection may be associated with a serving beam refinement, and/or a link quality (e.g., CQI or PMI) and interference adaptation. As another example, multiple measurement reports and/or values, collected at different points in time, may be input to the ML model 606. This may enable the ML model 606 to output codebook-based and/or non-codebook-based predictions for a measurement value, an AoD, and/or an AoA, among other examples, of a beam at a future time. The output(s) of the ML model 606, may facilitate initial access procedures, carrier aggregation (e.g., secondary cell setup), dual connectivity (e.g., secondary cell group (SCG) setup), beam refinement procedures (e.g., a transmit beam refinement procedures sometimes referred to as a P2 beam management procedure and/or a receive beam refinement procedure sometimes referred to as a P3 beam management procedure), link quality or interference adaptation procedures, beam failure and/or beam blockage predictions, and/or radio link failure predictions, among other examples.

In certain aspects, an output of the ML model 606 may include a temporal beam prediction, such as a TD beam prediction. The TD beam prediction may be associated with a serving beam refinement, a link quality (e.g., CQI or PMI) and interference adaptation, a beam failure/blockage prediction, and/or a radio link failure (RLF) prediction.

In certain aspects, the ML model 606 performs SD downlink beam predictions for beams included in the “Set-A beams” based on measurement results of beams included in the “Set-B beams.” In some aspects, the ML model 606 performs TD downlink beam prediction for beams included in the “Set-A beams” based on historic measurement results of beams included in the “Set-B beams.”

In certain aspects, a model server 650 (in communication with the UE 604 and/or the network node 602) may perform any of various ML model lifecycle management (LCM) tasks for the UE 604 and/or the network node 602. The model server 650 may operate as a model training host and update the ML model 606 using training data. In some cases, the model server 650 may operate as a data host to collect and host training data, inference data, and/or performance feedback associated with an ML model 606. In certain aspects, the model server 650 may host various types and/or versions of the ML model 606 for the UE 604 and/or the network node 602 to download.

In some cases, the model server 650 may monitor and evaluate the performance of the ML model 606 to trigger one or more LCM tasks. For example, the model server 650 may determine whether to activate or deactivate the use of a particular ML model at the UE 604 and/or the network node 602, and the model server 650 may provide such an instruction to the respective UE 604 and/or the network node 602. In some cases, the model server 650 may determine whether to switch to a different ML model 606 being used at the UE 604 and/or the network node 602, and the model server 650 may provide such an instruction to the respective UE 604 and/or the network node 602. In yet further examples, the model server 650 may also act or operate as a central server for decentralized machine learning tasks, such as federated learning.

In certain cases, the ML model 606 may be deployed at or on the model server 650 in communication with the UE 604 and/or the network node 602. The UE 604 may send input data (e.g., an indication of the first set of measurements 610) to the model server 650. The model server 650 may generate output data (e.g., an indication of the second set of measurements 612) using the ML model 606 based at least in part on the input data obtained from the UE 604. The UE 604 may obtain, from the model server 650, an indication of the second set of measurements 612. Accordingly, the ML model 606 may be deployed at or on a network node (such as the BS 102, the first network entity 300, the second network entity 302, the network node 602, the model server 650, and/or the like) to perform AI-based beam predictions as described herein.

Note that AI-aided beam prediction as described herein with respect to FIG. 6 is an example of AI-aided wireless communications. Aspects of the present disclosure may be applied to any other suitable AI/ML functions for wireless communications, such as radio resource management, CSI estimation and/or prediction, CSI compression and/or decompression (e.g., CSI encoding and/or decoding), data or signaling compression and/or decompression, device positioning (e.g., UE positioning and/or TRP positioning), UE mobility management, and/or the like.

### Aspects Related to Multi-Periodicity Synchronization Signaling

Aspects of the present disclosure provide various scheme(s) that enable communication of synchronization signaling with multiple periodicities. The multi-periodicity synchronization signaling may enable reduced power consumption and/or effective channel usage, as described herein.

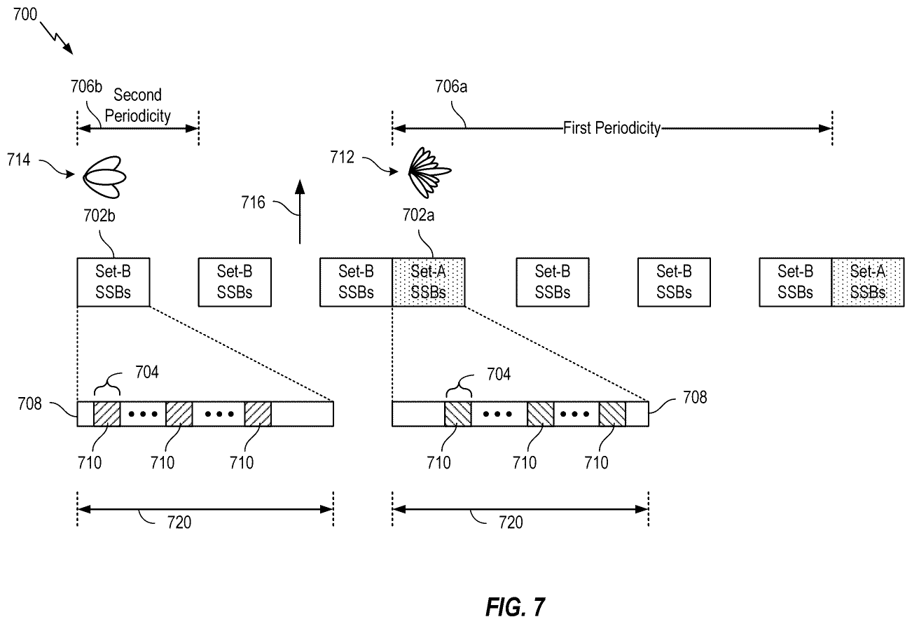

FIG. 7 depicts an example scheme 700 for communication of multi-periodicity synchronization signaling (for example, as shown arranged or allocated over time). In this example, synchronization signaling, which may be output by or at a network node (e.g., the network node 602), may be partitioned into a first set of synchronization signals (hereinafter “Set-A SSBs 702a”) and a second set of synchronization signals (hereinafter “Set-B SSBs 702b”). In certain cases, the synchronization signaling (e.g., the Set-A SSBs 702a and the Set-B SSBs 702b) may be communicated via (or allocated in) one or more frequency resources in the same carrier of a cell and/or with the same subcarrier spacing. The carrier may be a frequency range of one or more operating bands specified for wireless communications, such as an operating band of FR1, FR2, and/or any other suitable frequency range. As an example, a UE may monitor for the synchronization signaling in the carrier as part of initial cell search and/or cell reselection.

In certain cases, the synchronization signaling (e.g., the Set-A SSBs 702a and the Set-B SSBs 702b) may be communicated via (or allocated in) via one or more frequency resources in different carriers and/or with different subcarrier spacings, respectively, which may be associated with the same or different cell. As an example, the Set-A SSBs may be configured as virtual measurement resources and/or on-demand SSBs in a different carrier (and/or with a different subcarrier spacing) with respect to the carrier or subcarrier spacing associated with the Set-B SSBs.

The synchronization signaling may be associated with a plurality of transmission occasions (such as the transmission occasion 704) in which one or more synchronization signals may be communicated or allocated for communication. The associated transmission occasions may define a transmission pattern for the synchronization signaling. For example, the Set-A SSBs 702a may be arranged or communicated over (or in) time with a first periodicity 706a, and the Set-B SSBs 702b may be arranged or communicated over (or in) time with a second periodicity 706b. In certain aspects, the second periodicity 706b may have a different duration than the first periodicity 706a. As an example, the second periodicity 706b may have a shorter duration than the first periodicity 706a. The duration of the second periodicity 706b may be less than the duration of the first periodicity 706a. Thus, the Set-A SSBs 702a may be communicated less frequently than the Set-B SSBs 702b, which may enable reduced energy consumption (at a network node and/or a UE), effective channel usage, and/or the like, as described herein.

A set of synchronization signals (such as the Set-A SSBs 702a and/or the Set-B SSBs 702b) may be or include one or more reference signals or pilot signals, which may be generated using a known sequence of modulation symbols (e.g., binary phase shift keying (BPSK) symbols). Based on the known sequence(s) associated with the reference signal(s), the received reference signal(s) may enable a UE determine to time and/or frequency synchronization information (such as the propagation delay (e.g., phase shift) and/or frequency pre-compensations (e.g., Doppler shift compensations)) for wireless communications between the UE (e.g., the UE 604) and a network node (e.g., the network node 602). In certain aspects, a synchronization signal may indicate or include additional or alterative information a cell identifier and/or system information.

In certain cases, a set of synchronization signals (e.g., a set of SSBs or the like) arranged or communicated over time in a specified transmission time interval 720 (e.g., a half frame) may be referred to as a synchronization signal burst, SSB burst, or SSB burst set. As an example, the Set-A SSBs 702a may be arranged or communicated in a first instance of an SSB burst 708, and the Set-B SSBs 702b may be arranged or communicated in a second instance of the SSB burst 708. In certain cases, the Set-A SSBs 702a may be communicated in the SSB burst 708 with or without the Set-B SSBs 702b. In certain cases, the Set-A SSBs 702a and the Set-B SSBs 702b may be arranged in the same or different transmission occasions (such as set(s) of symbols across a sequence of symbols) of the corresponding SSB burst.

In the SSB burst 708, the network node may perform a transmit beam sweep via the corresponding set of synchronization signals (e.g. Set-A SSBs 702a and/or Set-B SSBs 702b). The transmit beam sweep may enable a UE to perform beam management procedures, such as beam selection, beam failure detection, and/or beam switching. In the SSB burst 708 associated with the Set-A SSBs 702a, the network node may send one or more synchronization signals (e.g., an SSB 710) per transmit beam among a set of transmit beams, such as a first set of transmit beams 712, which may be representative of the second set of transmit beams 614 of FIG. 6. As an example, the network node may transmit an SSB 710 of the Set-A SSBs 702a via a first transmit beam of the first set of transmit beams 712 in a transmission occasion of the SSB burst 708, and so forth for the remaining SSBs of the Set-A SSBs 702a (e.g., the SSBs 710). Accordingly, the Set-A SSBs 702a may be communicated via a first set of transmit beams 712 (such as the second set of transmit beams 614), and the Set-B SSBs 702b may be communicated via a second set of transmit beams 714 (such as the first set of transmit beams 608).

In certain cases, the network node may be configured to transmit an SSB or a set of SSBs upon receiving a request from a UE, for example, in order to further reduce energy consumption and/or channel usage on certain broadcast channel communications (such as synchronization signaling). Such an SSB may be referred to as an on-demand SSB. In order to facilitate an on-demand SSB and continue to provide synchronization information, the network node may periodically transmit certain synchronization signal(s), for example, via a discovery reference signal (DRS). The DRS may carry one or more synchronization signals and/or a configuration for requesting the on-demand SSB, for example, via a wake-up-signal (WUS, which may sometimes be referred to as a cell-WUS (C-WUS) or an uplink-WUS (UL-US)) in an uplink channel. In some cases, the DRS may be transmitted without the PBCH or reduced system information, and thus, a DRS transmission may consume less energy and channel capacity than an SSB. Accordingly, the network node may transmit the DRS periodically and an on-demand SSB in response to a C-WUS from a UE.

In certain aspects, the Set-A SSBs 702a and/or the Set-B SSBs 702b may be on-demand synchronization signaling and/or include one or more DRSs. As an example, the Set-A SSBs 702a may be or include one or more on-demand SSBs, and the Set-B SSBs 702b may be communicated periodically. As another example, the Set-A SSBs 702a may be communicated periodically, and the Set-B SSBs 702b may be or include one or more on-demand SSBs. As yet another example, the Set-A SSBs 702a may be or include one or more on-demand SSBs, and the Set-B SSBs 702b may be or include one or more on-demand SSBs.

In certain cases, the UE may send, to the network node, a request 716, for the network node, to send or transmit one or more on-demand synchronization signals (e.g., SSB(s)). As an example, the UE may send a WUS, which may indicate the request, for the network node, to send the on-demand SSB. The UE may be configured (e.g., via signaling from the network node) with one or more random access occasions (RO(s)) in which to send the request (e.g., a WUS) for communication of an on-demand SSB. The UE may be configured with a set of ROs associated with the Set-A SSBs 702a and/or the Set-B SSBs 702b. The association between the set of ROs and the Set-A SSBs 702a and/or the Set-B SSBs may indicate which RO(s) to use for communication of a WUS to request transmission of the SSB associated with the respective RO(s).

As an example, the UE may be configured with a first set of ROs associated with the Set-A SSBs 702a, and a second set of ROs associated with the Set-B SSBs 702b. The UE may send a WUS in an RO of the first set of ROs to request for communication of the Set-A SSBs 702a. The UE may send a WUS in an RO in the second set of ROs to request for communication of the Set-B SSBs 702b. In certain cases, the same set of ROs may be used to request communication of the Set-A SSBs 702a and/or the Set-B SSBs 702b. The set of ROs may be referred to as a cross set of ROs, for example, due to the association with the Set-A SSBs and the Set-B SSBs.

Note that the periodicities and/or time-domain arrangement of the Set-A SSBs 702a and the Set-B SSBs 702b depicted in FIG. 7 are merely examples to facilitate an understanding of multi-periodicity synchronization signaling. Aspects of the present disclosure may be applied to other suitable time-domain resource allocations for multi-periodicity synchronization signaling.

Note that an SSB (such as the SSB depicted in FIG. 4B) is merely an example signaling block for communication of synchronization signaling, and other suitable signaling blocks (e.g., different time and/or frequency domain arrangements for the PSS, SSS, and/or PBCH) may be used in addition to or instead of the SSB as described herein. In some cases, synchronization signaling or signal(s) may include a discovery reference signal (DRS) having one or more synchronization signals, such as a PSS, a SSS, and/or a tertiary synchronization signal (TSS). In certain cases, the DRS may include synchronization signal(s) without a PBCH and/or certain system information.

### Aspects Related to PBCH Combining

In certain aspects, a UE may perform PBCH combining in order to improve the demodulation performance of the PBCH. PBCH combining may refer to combining the synchronization signals received in different transmission occasions, such as different periodic instances of an SSB burst, and demodulating the combined signals to determine the system information carried in the PBCH. In certain cases, combining may include summing the amplitudes of the received signals in order to effectively increase the received signal strength of the signaling. The PBCH may carry certain system information (for example, the MIB) that enables a UE to communicate with a network node. As an example, the system information carried in the PBCH may indicate, for example, the current system frame number (in which the PBCH is communicated), the subcarrier spacing for the reception of SIB1, the size and location of a control channel (e.g., a control resource set (CORESET)), and/or the like. Thus, PBCH combining may increase the UE's likelihood of successfully demodulating and decoding the PBCH and establishing a communication link with a network node based on the system information carried in the PBCH.

In certain aspects, a UE may obtain certain information that enables the UE to perform PBCH combining for multi-periodicity synchronization signaling, for example, as described herein with respect to FIG. 7. As an example, due to the PBCH carrying dynamic system information (such as the current system frame number), the UE may determine which instances of SSB transmissions can be combined for PBCH combining. For example, the UE may be unable to combine any of the PBCHs of the Set-A SSBs (e.g., the Set-A SSBs 702a) with any of the PBCHs of the Set-B SSBs (e.g., the Set-B SSBs 702b), for example, due to the different information conveyed in the respective PBCHs.

In certain aspects, the synchronization signaling may include an indication (e.g., an explicit or implicit indication) of whether the synchronization signaling is part of the Set-A SSBs or the Set-B SSBs. As an example, the synchronization signaling of the Set-A SSBs may include an indication (e.g., an explicit indication) that the synchronization signaling is part of the Set-A SSBs. In certain cases, the synchronization signaling of the Set-B SSBs may include an indication (e.g., an explicit indication) that the synchronization signaling is part of the Set-B SSBs. The Set-A or Set-B indication may be included in the PSS, SSS, and/or DMRS of the SSB. Accordingly, the Set-A or Set-B indication may enable the UE to identify SSBs from the Set-A SSBs that can be used for PBCH combining or to identify SSBs from the Set-B SSBs that can be used for PBCH combining.

In certain aspects, an SSB in an SSB burst can be identified in part by an SSB index assigned to the SSB transmission in the SSB burst. As an example, the total number of SSB indexes of an SSB burst may include 4, 8, or 64 indexes, which may depend on the carrier and/or subcarrier spacing associated with the SSB burst. In certain cases, the SSB indexes may be partitioned into multiple sets of SSB indexes, such that an SSB index may indicate whether the PBCH combining can be performed, for example, using SSBs (from different instances of the SSB burst) having the same SSB index. As an example, the SSB indexes (e.g., indexes of 0-7) may be partitioned into a first set of SSB indexes (e.g., indexes of 0, 2, 4, and 6) and a second set of SSB indexes (e.g., indexes of 1, 3, 5, and 7). The first set of SSB indexes may be mapped (or assigned) to the Set-B SSBs or a portion thereof; and the second set of SSB indexes may be mapped (or assigned) to the Set-A SSBs and any remaining portion of the Set-B SSBs. The first set of SSB indexes may be used for the Set-B SSBs (or portion thereof), and the second set of SSB indexes may be used for the Set-A SSBs and any remaining Set-B SSBs. In certain cases, the second set of SSB indexes may be reserved for the Set-A SSBs.

The SSB index mapping between the sets of SSB indexes (e.g., the first set of SSB indexes and the second set of SSB indexes) and the synchronization signaling may be based at least in part on one or more characteristics associated with the synchronization signaling, such as operating band and/or subcarrier spacing. In certain cases, which SSBs of the Set-B SSBs that are mapped to the first set of SSB indexes may be determined based on the frequency band (e.g., carrier frequency or operating band), the subcarrier spacing, and/or the like. The frequency band or subcarrier spacing associated with the Set-B SSBs may determine which SSBs in an SSB burst are included in the first set of SSB indexes, which may be a subset of the Set-B SSB. For example, suppose the Set-B SSBs include a first SSB, a second SSB, a third SSB, and a fourth SSB arranged over time in the SSB burst. When the SSB burst is in an operating band below 3 GHZ, the first SSB and the second SSB may be mapped to the first set of SSB indexes, and the remaining SSBs of the Set-B SSBs may be mapped to the second set of SSB indexes. When the SSB burst is in an operating band is between 3 GHz and 6 GHz, the third SSB and the fourth SSB may be mapped to the first set of SSB indexes, and the remaining SSBs of the Set-B SSBs may be mapped to the second set of SSB indexes. Note that such a mapping is merely an example, and additional or alternative SSB index mappings may be applied to aspects of the present disclosure.

In certain cases, the total number of the first set of SSB indexes may be determined based on the frequency band (e.g., carrier frequency), the subcarrier spacing, and/or the like. As an example, when the SSB burst is in an operating band below 3 GHZ, the total number of first SSB indexes may be set to two; when the SSB burst is in an operating band between 3 GHz and 6 GHZ, the total number of first SSB indexes may be set to four; and when the SSB burst is in an operating band above 6 GHz, the total number of first SSB indexes may be set to thirty two.

In certain cases, the UE may obtain an indication of the mapping between the first set of SSB indexes and the synchronization signaling (e.g., some or all of the Set-B SSBs) and/or the mapping between the second set of SSB indexes and the synchronization signaling (for example, the Set-A SSBs and any remaining Set-B SSBs). In certain cases, the mapping indication for the second set of SSB indexes may be indicated via an explicit or implicit indication included in the PSS, SSS, and/or DMRS of an SSB. An explicit indication may be or include a field dedicated to indicating the SSB index mapping. An implicit indication may be or include an indication of the SSB index mapping that is capable of being determined without being expressly indicated, such as the operating band or subcarrier spacing indicating the SSB index mapping. In certain cases, the mapping indication for the second set of SSB indexes may be indicated via RRC signaling (for example, for UEs in an RRC connected state), MAC signaling, DCI, and/or certain system information, such as SIB1 and/or any other suitable system information block.

Note that PBCH combining is merely an example operation which may be enabled by or at least part Set-A or Set-B indication and/or the SSB index mapping. Aspects of the present disclosure may apply to additional or alternative operations which depend on the Set-A or Set-B indication and/or the SSB index mapping.

### Aspects Related to SSB to RO Mapping

During an SSB burst (e.g., the SSB burst 708), the network node may perform a transmission beam sweep via SSBs, for example, by at least in part transmitting one or more SSBs per transmission beam of the network node. The UE may measure the received signal power of the SSBs, and the UE may select the SSB that has a received signal power that satisfies a threshold (e.g., a threshold RSRP), such as selecting a SSB that has a received signal power above the threshold RSRP. If none of the SSBs have a signal strength above the threshold, the UE may select any SSB among the candidate SSBs. Each of the SSBs may be mapped to or associated with one or more ROs (e.g., via signaling or a specified configuration).

As an example, the UE may be configured with a mapping of SSB indexes to ROs according to certain mapping rule(s), as further described herein. The UE may identify the RO associated with the selected SSB via the SSB to RO mapping, and the UE may send a random access message (e.g., a random access preamble) in the RO, for example, as part of the random access procedures described herein with respect to FIGS. 5A and 5B. Communication of the preamble in the RO may indicate the UE's request for the network node to communicate via the transmission beam associated with the selected SSB due to the association between the RO and the SSB. The indication of the SSB selection with the preamble transmission indicates the UE's preferred transmit beamforming at the network node. Accordingly, the network node may transmit the random access response to the UE using the transmission beam associated with the RO and SSB.

In certain aspects, certain mapping rule(s) of an SSB to RO mapping may specify the distribution of the association of SSBs across the ROs. In certain cases, the SSB to RO mapping may distribute the association of SSBs across the ROs equally, such that each of the SSBs may be associated with the same number of ROs in a periodic cycle of ROs. As an example, the mapping rule(s) may indicate or specify that successive SSB indexes may be mapped to RO identifiers based first in order of preamble indexes within an RO, then in order of frequency resource indexes for the ROs (e.g., PRACH frequency occasions), and then in order of time resource indexes for the ROs (e.g., PRACH time occasions) in PRACH slots. In some cases, multiples SSBs may be mapped to a single RO, and a combination of the preamble and the RO (or alternative or additional parameters) may indicate the transmission beam associated with the SSB.

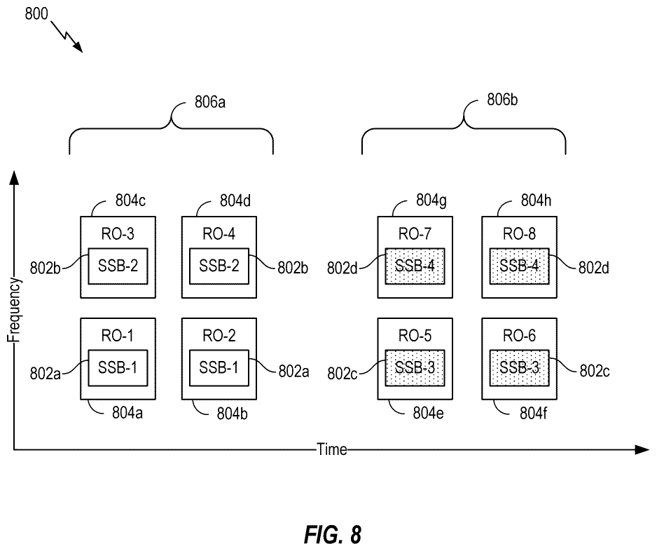

FIG. 8 depicts an example scheme 800 for mapping ROs to SSBs associated with the Set-A SSBs and the Set-B SSBs. In this example, a first RO 804a and a second RO 804b may be associated with a first SSB 802a, which may be communicated via a first transmission beam of a network node (e.g., the network node 602). A third RO 804c and a fourth RO 804d may be associated with a second SSB 802b, which may be communicated via a second transmission beam of the network node. The first RO 804a and second RO 804b may overlap at least partially in time with the third RO 804c and the fourth RO 804d, respectively. As an example, the first SSB 802a and the second SSB 802b may be part of the Set-B SSBs, for example, as described herein with respect to FIG. 7.

A fifth RO 804e and a sixth RO 804f may be associated with a third SSB 802c, which may be communicated via a third transmission beam of the network node. A seventh RO 804g and an eighth RO 804h may be associated with the fourth SSB 802d, which may be communicated via a fourth transmission beam of the network node. The fifth RO 804e and sixth RO 804f may overlap at least partially in time with the seventh RO 804g and eighth RO 804h, respectively. As an example, the third SSB 802c and the fourth SSB 802d may be part of the Set-A SSBs, for example, as described herein with respect to FIG. 7.

In certain aspects, the ROs may be mapped to each of the SSBs among the Set-A SSBs (e.g., the Set-A SSBs 702a) and the Set-B SSBs (e.g., the Set-B SSBs 702b) regardless of the different periodicities associated with the SSBs. As an example with respect to FIG. 8, the ROs 804a-h may be mapped to the SSBs 802a-d according to certain mapping rules regardless of the different periodicities associated with the SSBs. The random access configuration may not distinguish between the Set-A SSBs and the Set-B SSBs. Thus, the ROs may be mapped to the SSB indexes according to the mapping rule(s) described herein, for example, first in order of preamble indexes within an RO, then in order of frequency resource indexes for the ROs (e.g., PRACH frequency occasions), and then in order of time resource indexes for the ROs (e.g., PRACH time occasions) in PRACH slots.

In certain cases, the UE may select an SSB of the Set-A SSBs based on measurements of the Set-B SSBs, for example, as described herein with respect to FIG. 6. As an example, the UE may select a narrow transmit beam associated with the Set-A SSBs based on measurements of the Set-B SSBs via wide transmit beams. Then, the UE may send a random access preamble in the RO associated with the SSB of the Set-A SSBs, for example, according to the mapping rule(s). In certain aspects, certain system information may indicate the SSB indexes associated with the Set-A SSBs and the Set-B SSBs to enable the UE to identify the RO associated with the Set-A SSBs.

In certain cases, the ROs may be partitioned into multiple sets of ROs (for example, including a first set of ROs 806a and a second set of ROs 806b) in order to distribute the association of the Set-A SSBs and the Set-B SSBs across the first set of ROs 806a and a second set of ROs 806b. For example, the SSBs 802c, 802d of the Set-A SSBs may be distributed across or mapped to the second set of ROs 806b; and the SSBs 802a, 802b of the Set-B SSBs may be distributed across or mapped to the first set of ROs 806a. In certain aspects, the SSBs 802c, 802d of the Set-A SSBs may be mapped to the second set of ROs 806a according to the mapping rule(s) described herein, for example, first in order of preamble indexes within an RO, then in order of frequency resource indexes for the ROs (e.g., PRACH frequency occasions), and then in order of time resource indexes for the ROs (e.g., PRACH time occasions) in PRACH slots. In certain aspects, the SSBs 802a, 802b of the Set-B SSBs may be mapped to the first set of ROs 806a according to the mapping rule(s) described herein, for example, first in order of preamble indexes within an RO, then in order of frequency resource indexes for the ROs (e.g., PRACH frequency occasions), and then in order of time resource indexes for the ROs (e.g., PRACH time occasions) in PRACH slots.

In certain cases, the total number of ROs in the first set of ROs 806a may be different than the total number of ROs in the second set of ROs 806b. The total number of ROs in the second set of ROs 806b may be weighted or scaled to allow for more ROs to be allocated to the second set of ROs 806b than the first set of ROs 806a, or vice versa. As an example, the total number of ROs for the second set of ROs 806b (RO_{setA}) may be determined according to the following expression:

$${RO}_{SetA} = XM / ( YN + XM ) * ( total ROs ) \qquad ( 1 )$$

where Y is the total number of SSBs in the Set-B SSBs; X is the total number SSBs in the Set-A SSBs; N is the scaling factor for the Set-B SSBs; M is the scaling factor for the Set-A SSBs; and total ROs is the overall total of ROs allocated for random access communications. The total number of ROs for the first set of ROs 806a (RO_{setB}) may be determined according to the following expression:

$${RO}_{SetB} = YN / ( YN + XM ) * ( total ROs ) \qquad ( 2 )$$

Such a mapping of the SSBs among the Set-A SSBs and the Set-B SSBs across multiple sets of ROs may allow UEs with or without AI/ML capabilities to communicate via a sufficient number of ROs for the Set-A SSBs and/or the Set-B SSBs, depending on the weight or scaling applied to the ROs. In certain aspects, the weight or scaling may depend on the RO traffic load on the first set of ROs and the second set of ROs. For example, when more random access communications are occurring via the second set of ROs relative to the first set of ROs, a network node may increase the total number of ROs allocated for the second set of ROs and decrease the total number of ROs allocated for the first set of ROs, or vice versa.

In certain aspects, a UE may obtain an indication of the size of the first set of ROs and/or the second set of ROs, for example, based on Expressions (1) and (2). For example, the size of the first set of ROs and/or the second set of ROs may be indicated via values for the scaling factors M and/or N. In certain aspects, the UE may obtain an indication of the mapping between the Set-A SSBs and the first set of ROs and/or the mapping between the Set-B SSBs and the second set of ROs. Such indication(s) may be communicated via RRC signaling, MAC signaling, DCI, system information, or the like.

In certain aspects, certain random access parameters may be configured for the first set of ROs and/or the second set of ROs. A RACH configuration may indicate the random access parameters for random access communications. The random access parameters may be the same or different for the first set of ROs and the second set of ROs, for example, depending on the traffic load encountered on the respective set of ROs. The random access parameters may include, for example, a power-ramping step, an RSRP threshold for SSB measurements, a target receive power, a number of random access attempts, and/or the like. In certain aspects, the RACH configuration for first set of ROs and/or the second set of ROs may be communicated via system information. In certain cases, the RACH configuration for the first set of ROs may be indicated relative to the RACH configuration for the second set of ROs, for example, as a delta between the Set-B parameter(s) and the Set-A parameters associated with the RACH configurations.

Note that the SSBs 802a-d depicted in FIG. 8 are merely representative of the association or mapping between the respective RO and SSB and not the time-frequency resource(s) used or allocated for communication of the SSBs 802a-d; whereas the ROs 804a-h are representative of the time-frequency resource(s) used or allocated for random access communications in the respective ROs, such as MSG1 transmission(s).

### Aspects Related to Synchronization Signaling Measurements

As described herein with respect to FIG. 6, for inference operation(s), a UE may measure signaling (e.g., the Set-B SSBs 702b) communicated via the Set-B beams in order to determine prediction(s) of measurement(s) or characteristic(s) associated with the Set-A beams (e.g., prediction target(s)). The predicted measurement(s) or characteristic(s) may be or include channel characteristic(s) associated with the Set-A beams. In certain cases, the predicted measurement(s) or characteristic(s) may be or include, for example, a signal-to-noise ratio (SNR), a signal-to-interference plus noise ratio (SINR), a signal-to-noise-plus-distortion ratio (SNDR), a received signal strength indicator (RSSI), a reference signal received power (RSRP), a reference signal received quality (RSRQ), a block error rate (BLER), and/or the like. Accordingly, in the context of inference operation(s), obtaining measurement(s) or characteristic(s) of Set-A beams may include obtaining prediction(s) of measurement(s) or characteristic(s) of Set-A beams based at least in part on the received signaling communicated via the Set-B beams, as described herein with respect to FIG. 6.

In certain aspects, a UE may measure or monitor the synchronization signaling associated with the Set-A SSBs (e.g., the Set-A SSBs 702a) and/or the Set-B SSBs (e.g., the Set-B SSBs 702b), for example, for radio resource management. Radio resource management may refer to certain procedures that enable a UE to establish and/or maintain a wireless communication link with one or more network nodes. Radio resource management may include cell selection (or reselection), beam management (e.g., beam selection, beam refinement, and/or beam switching), radio link failure detection and recovery, or the like.

Depending on the AI/ML capabilities of a UE, the UE may perform certain radio resource management procedures based on characteristic(s) associated with the Set-B SSBs and/or prediction of characteristic(s) associated with the Set-A SSBs. In certain aspects, radio resource management procedures (e.g., beam selection and/or beam refinement) may be performed based on prediction of characteristic(s) associated with the Set-A SSBs if the UE is capable of performing inference operations or a portion thereof (e.g., providing feedback to a model server that offloads inference operations). As an example, the UE may select an SSB of the Set-A SSBs as part of a transmit beam refinement procedure based on a prediction of the RSRP associated with the SSB satisfying a threshold RSRP. In certain cases, the radio resource management procedures may be performed based on characteristic(s) associated with the Set-B SSBs if the UE is not capable of performing inference operations or a portion thereof. As an example, the UE may select an SSB of the Set-B SSBs as part of a transmit beam refinement procedure based on a measured RSRP of the SSB satisfying a threshold RSRP.

For a UE in idle mode or inactive mode, the UE may determine whether to perform radio resource management procedure(s) based on characteristic(s) associated with the Set-B SSBs and/or prediction of characteristic(s) associated with the Set-A SSBs. As an example, cell reselection may be based on characteristic(s) associated with the Set-B SSBs if the UE does not support AI/ML inference operations. If the UE supports AI/ML inference operations, the cell reselection may be based on characteristic(s) associated with the Set-B SSBs (e.g., characteristics derived from the received signaling of the Set-B SSBs) and/or prediction of characteristic(s) associated with the Set-A SSBs (e.g., derived from the received signaling of the Set-B SSBs), for example, satisfying a threshold.

For a UE in connected mode, the network node may configure the UE to perform radio resource management procedures based on characteristic(s) associated with the Set-B SSBs (e.g., characteristics derived from the received signaling of the Set-B SSBs) and/or prediction of characteristic(s) associated with the Set-A SSBs (e.g., derived from the received signaling of the Set-B SSBs), for example, satisfying a threshold. In certain aspects, the configuration may be based on UE capability information indicating whether the UE has AI/ML capabilities. In certain aspects, the UE may determine whether to perform radio resource management procedures based on characteristic(s) associated with the Set-B SSBs and/or prediction of characteristic(s) associated with the Set-A SSBs.

Aspects of the present disclosure may be applied to various types of radio resource management operations including, for example, inter-DU-intra-CU handover, inter-CU handover, (conditional) lower-layer triggered mobility (LTM), layer-three (L3) mobility, an Xn based handover, an N2 based handover, conditional handover (CHO), beam selection, beam switch, (conditional) serving cell modification or change, (conditional) serving cell addition, (conditional) serving cell release, cell group modification, cell group addition, cell group release, dual active protocol stack (DAPS) handover, dual connectivity, or the like. In certain aspects, a radio resource management operation may be triggered, for example, due to various criteria being satisfied, such as radio conditions (e.g., in response to a measurement report), load balancing at a network node, and/or a specific service (e.g., certain QoS specification(s) for communications can be satisfied by the handover).

As an example, as part of LTM preparation and/or LTM execution, the UE may monitor the characteristic(s) associated with the Set-B SSBs and/or prediction of characteristic(s) associated with the Set-A SSBs across all or a portion of the cells configured for LTM. As another example, the UE may autonomously switch from a serving cell to a candidate cell as part of a CHO procedure based on the characteristic(s) associated with the Set-B SSBs and/or prediction of characteristic(s) associated with the Set-A SSBs across all or a portion of the cells in the CHO set.

Accordingly, the multi-periodicity synchronization signaling may enable reduced power consumption at the network node and/or the UE, for example, due to the reduction in transmission and/or measurement of synchronization signaling associated with the Set-A SSBs. In certain cases, the multi-periodicity synchronization signaling may enable effective channel usage for wireless communications, for example, due to the network node reallocating communication resources, which would be used by the Set-A SSBs with a shorter periodicity.

### Example Signaling of Multi-Periodicity Synchronization Signaling

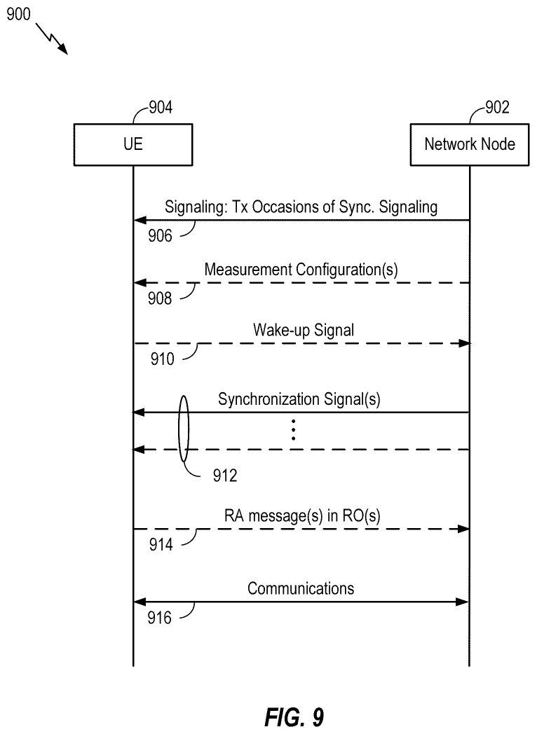

FIG. 9 depicts a process flow 900 for multi-periodicity synchronization signaling in a system between a network node 902 and a UE 904. In some aspects, the network node 902 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 904 may be an example of UE 104 depicted and described with respect to FIG. 1 or the UE 304 depicted and described with respect to FIG. 3. However, in other aspects, UE 904 may be another type of wireless communications device, and network node 902 may be another type of network entity or network node, such as those described herein. Note that any operations or signaling illustrated with dashed lines may indicate that that operation or signaling is an optional or alternative example.

At 906, the UE 904 obtains, from the network node 902, signaling that includes an indication of transmission occasions associated with synchronization signaling. As an example, the synchronization signaling may include a first set of synchronization signals (e.g., Set-A SSBs) and a second set of synchronization signals (e.g., Set-B SSBs) as described herein with respect to FIG. 7. The indication of the transmission occasions may indicate the different periodicities associated with the Set-A SSBs and the Set-B SSBs. The signaling may be communicated via system information, RRC signaling (e.g., an RRC configuration), MAC signaling, DCI, or the like. As an example, system information (e.g., SIB1) and/or RRC signaling (e.g., a serving cell configuration) may indicate the transmission occasions in which SSBs (e.g., Set-A SSBs and/or Set-B SSBs) are communicated or allocated for communication in an SSB burst, as described herein with respect to FIG. 7. A bit string or bitmap (e.g., the field ssb-PositionsInBurst) may indicate which transmission occasions are active (among a set of candidate SSB transmission occasions in an SSB burst) for SSB communications in an SSB burst associated with Set-A SSBs and/or Set-B SSBs.

In certain aspects, the signaling may include an indication of the set(s) of ROs associated with the Set-A SSBs and/or Set-B SSBs, for wake-up signal communications in association with on-demand SSB(s), for example, as described herein with respect to FIG. 7.

In certain aspects, the signaling may include an indication of the set(s) of ROs associated with the Set-A SSBs and/or Set-B SSBs for random access communications, for example, as described herein with respect to FIG. 8.

In certain aspects, for example to enable PBCH combining, the signaling may include a Set-A or Set-B indication (for example, to indicate whether the SSB is part of the Set-A SSBs or the Set-B SSBs) and/or an indication of the SSB index mapping of the SSBs among multiple sets of SSB indexes.

At 908, the UE 904 optionally obtains, from the network node 902, an indication of measurement configuration(s) associated with the synchronization signaling. The measurement configuration(s) may specify or indicate one or more parameters associated with radio resource management operation(s). The radio resource management operation(s) may include, for example, CSI measurement, CSI reporting, beam management, cell selection or reselection, radio link failure recovery, handover procedures (e.g., Layer-3 handover, CHO, and/or LTM), or the like.

In certain cases, the measurement configuration(s) may indicate that prediction of a first set of characteristics associated with a first set of synchronization signals (e.g., Set-A SSBs) is based on a second set of characteristics associated with a second set of synchronization signals (e.g., Set-B SSBs), for example, as described herein with respect to FIGS. 6 and 7. The measurement configuration(s) may indicate that certain radio resource management operation(s) (e.g., radio link failure recovery, beam switch, beam refinement, CHO, or the like) may be triggered based on the prediction of the first set of characteristics satisfying a threshold. As an example, when the prediction of the first set of characteristics satisfies the threshold (e.g., a predicted RSRP is above or below the threshold, depending on the operation), the UE may perform a radio resource management operation or a part thereof, for example, as described herein.

In certain cases, the measurement configuration(s) may indicate that certain radio resource management operation(s) may be triggered based on the second set of characteristics associated with the second set of synchronization signals (e.g., Set-B SSBs) derived from the received SSBs from the Set-B SSBs. As an example, when the second set of characteristics satisfies the threshold (e.g., a measured RSRP is above or below the threshold, depending on the operation), the UE may perform a radio resource management operation or a part thereof, for example, as described herein. The measurement configuration(s) may be communicated via system information, RRC signaling (e.g., an RRC configuration), MAC signaling, DCI, or the like.

At 910, the UE 904 optionally sends, to the network node 902, a wake-up signal that request transmission of one or more synchronization signals (e.g., SSB(s) of Set-A SSBs and/or Set-B SSBs). As discussed, the synchronization signaling (e.g., including Set-A SSBs and/or Set-B SSBs or a portion thereof) may be configured as on-demand SSB(s). The wake-up signal may trigger the transmission of on-demand SSB(s), which may be part of Set-A SSBs and/or Set-B SSBs, as described herein with respect to FIG. 7.

In certain aspects, the wake-up signal may be communicated in one or more ROs indicated via the signaling communicated at 906. For example, the signaling may include an indication of set(s) of ROs associated with the Set-A SSBs and/or Set-B SSBs, as described herein with respect to FIG. 7.

At 912, the UE 904 obtains, from the network node 902, at least one synchronization signal of the synchronization signaling in a transmission occasion of the plurality of transmission occasions, for example, as described herein with respect to FIG. 7. The synchronization signal(s) may include one or more SSBs of the Set-A SSBs and/or Set-B SSBs. In certain cases, the synchronization signal(s) may include a DRS, for example, as described herein with respect to FIG. 7.

In certain aspects, the synchronization signal(s) may be communicated with different periodicities. As described herein, the multi-periodicity synchronization signaling may enable reduced power consumption at the network node 902 and/or the UE 904, for example, due to the reduction in transmission and/or measurement of synchronization signaling associated with the Set-A SSBs. In certain cases, the multi-periodicity synchronization signaling may enable effective channel usage for wireless communications, for example, due to the network node 902 reallocating communication resources, which would be used by the Set-A SSBs with a shorter periodicity.

At 914, the UE 904 optionally sends, to the network node 902, a random access message in at least one RO, for example, as described herein with respect to FIGS. 5A, 5B, and 8. In certain cases, the RO may be associated with the synchronization signal obtained at 912. In certain cases, the RO may be associated with a prediction target (such as an SSB of the Set-A SSBs) of an inference operation, for example, in association with AI-based wireless communications. As an example, the UE 904 may predict a characteristic associated with a first SSB of the Set-A SSBs based on measurement(s) of a second SSB of the Set-B SSBs received at 912; and the UE 904 may send the random access in the RO associated with the first SSB based on the predicted characteristic (e.g., a predicted RSRP) satisfying a threshold (e.g., a threshold RSRP).

A prediction target may be or include communication resources(s), measurement resource(s), and/or virtual resources(s) (e.g., virtual communication resources and/or virtual measurement resources), for example, associated with Set-A beams and/or Set-A SSBs, as described herein with respect to FIGS. 6 and 7. A virtual measurement resource may be or include one or more time-frequency resources in which signaling is not actually communicated (e.g., transmitted), but for AI-based wireless communications, measurement(s) or characteristic(s) associated with a virtual measurement resource may be predicted as though signaling is communicated via the virtual measurement resource. Aspects of the present disclosure may be applicable to virtual resource(s), for example, assigned to or associated with Set-A beams, for example, in association with interference operations. A measurement resource may be or include one or more time-frequency resources allocated for measurement or communication of signaling and/or for prediction of characteristic(s) of the signaling. As an example, the measurement resource may be or include a set of time-frequency resources in which synchronization signaling is communicated, allocated for communication, or identified as a prediction target for training data collection, inference, and/or performance monitoring associated with AI-based wireless communications.

At 916, the UE 904 communicates with the network node 902 based at least in part on the synchronization signal obtained at 912. In certain cases, the UE 904 may perform various radio resource management operations based on the prediction of the characteristic(s) associated with the Set-A SSBs, for example, as described herein with respect to FIGS. 6 and 7. As an example, the UE 904 may establish a communication link with the network node 902 via a transmit beam associated with an SSB of the Set-A SSBs, and the UE 904 may select the transmit beam based on the prediction of the characteristic(s) associated with Set-A SSBs (e.g., a predicted RSRP satisfying a threshold). Note that beam selection or beam refinement is merely an example. Other radio resource management operations may be facilitated by at least in part the prediction of characteristic(s) associated with the Set-A SSBs.

Note that the process flow illustrated in FIG. 9 is an example of multi-periodicity synchronization signaling, and aspects of the present disclosure may be applied to various radio resource management operation(s), which may depend on synchronization signaling. Note that the process flow illustrated in FIG. 9 is described herein to facilitate an understanding of multi-periodicity synchronization signaling, and aspects of the present disclosure may be performed in various manners via alternative or additional signaling and/or operations. In certain aspects, the operations and/or signaling of FIG. 9 may occur in an order different from that described or depicted, and various actions, operations, and/or signaling may be added, omitted, or combined.

### Example Operations Related to Communication of Multi-Periodicity Synchronization Signaling

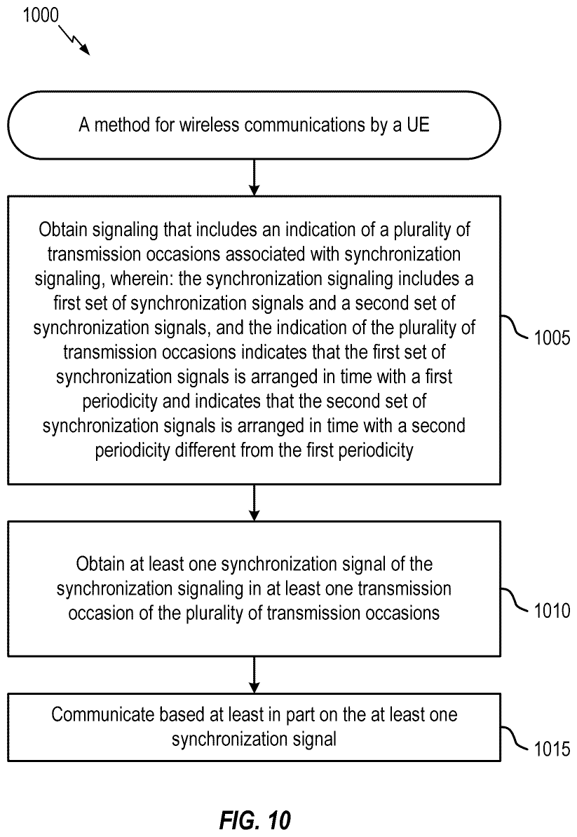

FIG. 10 shows a method 1000 for wireless communications by a UE, such as UE 104 of FIG. 1 or UE 304 of FIG. 3.

Method 1000 begins at block 1005 with obtaining signaling that includes an indication of a plurality of transmission occasions associated with synchronization signaling, wherein: the synchronization signaling includes a first set of synchronization signals and a second set of synchronization signals, and the indication of the plurality of transmission occasions indicates that the first set of synchronization signals is arranged in time with a first periodicity and indicates that the second set of synchronization signals is arranged in time with a second periodicity different from the first periodicity, for example, as described herein with respect to FIGS. 7 and 9.

Method 1000 then proceeds to block 1010 with obtaining at least one synchronization signal of the synchronization signaling in at least one transmission occasion of the plurality of transmission occasions, for example, as described herein with respect to FIGS. 7 and 9.

Method 1000 then proceeds to block 1015 with communicating based at least in part on the at least one synchronization signal, for example, as described herein with respect to FIGS. 7 and 9.

In some aspects, the second periodicity is less than the first periodicity.

In some aspects, the synchronization signaling is arranged (or allocated) in a carrier associated with a cell.

In some aspects, the signaling further includes one or more of: an indication that the first set of synchronization signals includes on-demand synchronization signaling; or an indication that the second set of synchronization signals includes on-demand synchronization signaling.

In some aspects, the signaling further includes: an indication of a first set of random access occasions associated with the first set of synchronization signals, and an indication of a second set of random access occasions associated with the second set of synchronization signals; and the method 1000 further comprises sending, in at least one random access occasion of the first set of random access occasions, a wake-up signal that requests transmission of the first set of synchronization signals.

In some aspects, the signaling further includes an indication of a set of random access occasions associated with the first set of synchronization signals and the second set of synchronization signals; and the method 1000 further comprises sending, in at least one random access occasion of the set of random access occasions, a wake-up signal that requests transmission of the first set of synchronization signals.

In some aspects, the at least one synchronization signal includes an explicit indication of whether the at least one synchronization signal is part of (i) the first set of synchronization signals or (ii) the second set of synchronization signals.

In some aspects, the signaling further includes an indication of a SSB index mapping between a set of SSB indexes and the synchronization signaling, wherein the indication of the SSB index mapping indicates that the set of SSB indexes is partitioned into a first set of SSB indexes mapped to at least a first portion of the second set of synchronization signals and a second set of SSB indexes mapped to at least the second set of synchronization signals.

In some aspects, indication of the SSB index mapping indicates that the second set of SSB indexes is further mapped to a second portion of the second set of synchronization signals.

In some aspects, the SSB index mapping is based at least in part on one or more characteristics of the synchronization signaling.

In some aspects, the signaling further includes an indication of an association between a set of random access occasions and the synchronization signaling; and the method 1000 further comprises sending a random access message in at least one random access occasion of the set of random access occasions, wherein the at least one random access occasion is associated with the at least one synchronization signal, for example, as described herein with respect to FIGS. 5A, 5B, 8 and 9.

In some aspects, the indication of the association indicates that the set of random access occasions is partitioned into a first set of random access occasions associated with the first set of synchronization signals and a second set of random access occasions associated with the second set of synchronization signals, for example, as described herein with respect to FIGS. 5A, 5B, 8 and 9.

In some aspects, the signaling further includes: an indication of a first set of random access parameters associated with the first set of synchronization signals; and an indication of a second set of random access parameters associated with the second set of synchronization signals, for example, as described herein with respect to FIGS. 5A, 5B, 8 and 9.

In some aspects, method 1000 further includes obtaining an indication that prediction of a first set of characteristics associated with the first set of synchronization signals is based on a second set of characteristics associated with the second set of synchronization signals; and block 1015 includes communicating based at least in part on the prediction of the first set of characteristics associated with the first set of synchronization signals and the second set of characteristics associated with the second set of synchronization signals, for example, as described herein with respect to FIGS. 6 and 9.

In some aspects, block 1015 includes communicating based at least in part on the second set of characteristics associated with the second set of synchronization signals.

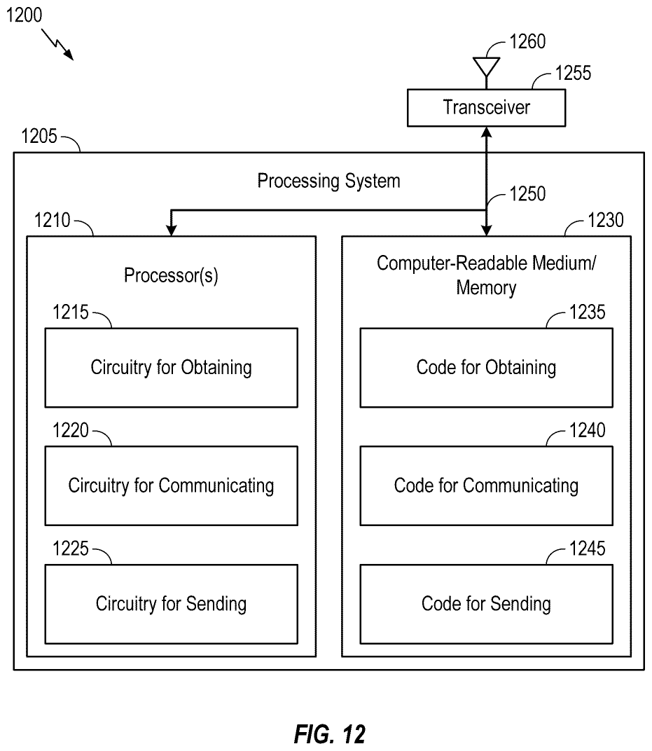

In some aspects, method 1000, or any aspect related to it, may be performed by an apparatus, such as communications device 1200 of FIG. 12, which includes various components operable, configured, or adapted to perform the method 1000.

Communications device 1200 is described below in further detail.

Note that FIG. 10 is just one example of a method, and other methods including fewer, additional, or alternative operations are possible consistent with this disclosure.

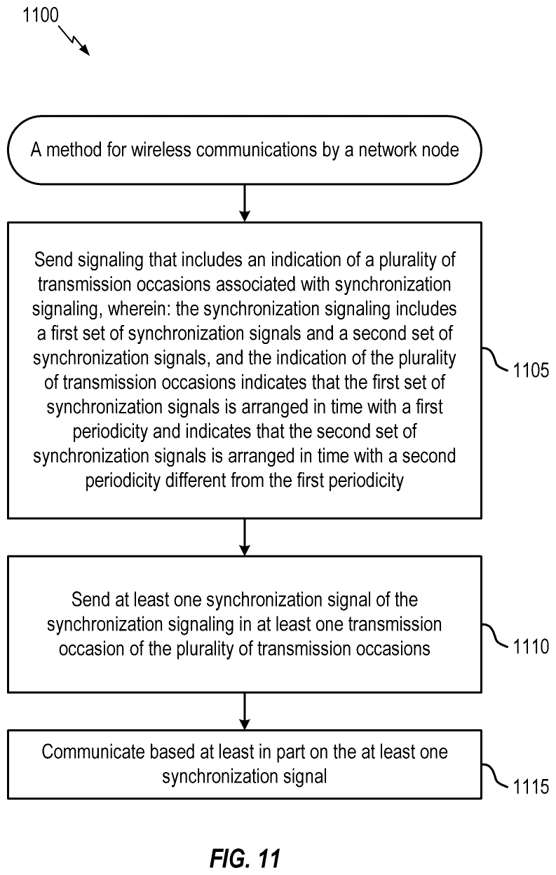

FIG. 11 shows a method 1100 for wireless communications by a network node, such as BS 102 of FIG. 1, a first network entity 300 or second network entity 302 of FIG. 3, or a disaggregated base station as discussed with respect to FIG. 2.

Method 1100 begins at block 1105 with sending signaling that includes an indication of a plurality of transmission occasions associated with synchronization signaling, wherein: the synchronization signaling includes a first set of synchronization signals and a second set of synchronization signals, and the indication of the plurality of transmission occasions indicates that the first set of synchronization signals is arranged in time with a first periodicity and indicates that the second set of synchronization signals is arranged in time with a second periodicity different from the first periodicity, for example, as described herein with respect to FIGS. 7 and 9.

Method 1100 then proceeds to block 1110 with sending at least one synchronization signal of the synchronization signaling in at least one transmission occasion of the plurality of transmission occasions, for example, as described herein with respect to FIGS. 7 and 9.

Method 1100 then proceeds to block 1115 with communicating based at least in part on the at least one synchronization signal, for example, as described herein with respect to FIGS. 7 and 9.

In some aspects, the second periodicity is less than the first periodicity.

In some aspects, the synchronization signaling is arranged (or allocated) in a carrier associated with a cell.

In some aspects, the signaling further includes one or more of: an indication that the first set of synchronization signals includes on-demand synchronization signaling; or an indication that the second set of synchronization signals includes on-demand synchronization signaling.

In some aspects, the signaling further includes: an indication of a first set of random access occasions associated with the first set of synchronization signals, and an indication of a second set of random access occasions associated with the second set of synchronization signals; and the method 1100 further comprises obtaining, in at least one random access occasion of the first set of random access occasions, a wake-up signal that requests transmission of the first set of synchronization signals.

In some aspects, the signaling further includes an indication of a set of random access occasions associated with the first set of synchronization signals and the second set of synchronization signals; and the method 1100 further comprises obtaining, in at least one random access occasion of the set of random access occasions, a wake-up signal that requests transmission of the first set of synchronization signals.

In some aspects, the at least one synchronization signal includes an explicit indication of whether the at least one synchronization signal is part of (i) the first set of synchronization signals or (ii) the second set of synchronization signals.

In some aspects, the signaling further includes an indication of a SSB index mapping between a set of SSB indexes and the synchronization signaling, wherein the indication of the SSB index mapping indicates that the set of SSB indexes is partitioned into a first set of SSB indexes mapped to at least a first portion of the second set of synchronization signals and a second set of SSB indexes mapped to at least the second set of synchronization signals.

In some aspects, indication of the SSB index mapping indicates that the second set of SSB indexes is further mapped to a second portion of the second set of synchronization signals.

In some aspects, the SSB index mapping is based at least in part on one or more characteristics of the synchronization signaling.

In some aspects, the signaling further includes an indication of an association between a set of random access occasions and the synchronization signaling; and the method 1100 further comprises obtaining a random access message in at least one random access occasion of the set of random access occasions, wherein the at least one random access occasion is associated with the at least one synchronization signal, for example, as described herein with respect to FIGS. 5A, 5B, 8 and 9.

In some aspects, the indication of the association indicates that the set of random access occasions is partitioned into a first set of random access occasions associated with the first set of synchronization signals and a second set of random access occasions associated with the second set of synchronization signals, for example, as described herein with respect to FIGS. 5A, 5B, 8 and 9.

In some aspects, the signaling further includes: an indication of a first set of random access parameters associated with the first set of synchronization signals; and an indication of a second set of random access parameters associated with the second set of synchronization signals, for example, as described herein with respect to FIGS. 5A, 5B, 8 and 9.

In some aspects, the method 1100 further comprises sending an indication that prediction of a first set of characteristics associated with the first set of synchronization signals is based on a second set of characteristics associated with the second set of synchronization signals; and block 1115 includes communicating based at least in part on the prediction of the first set of characteristics associated with the first set of synchronization signals and the second set of characteristics associated with the second set of synchronization signals, for example, as described herein with respect to FIGS. 6 and 9.

In some aspects, block 1115 includes communicating based at least in part on the second set of characteristics associated with the second set of synchronization signals.

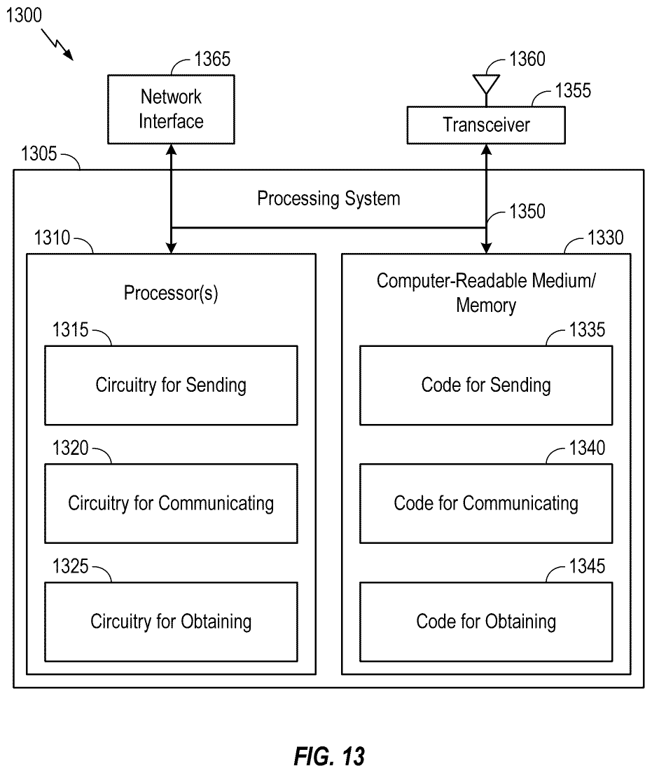

In some aspects, method 1100, or any aspect related to it, may be performed by an apparatus, such as communications device 1300 of FIG. 13, which includes various components operable, configured, or adapted to perform the method 1100.

Communications device 1300 is described below in further detail.

Note that FIG. 11 is just one example of a method, and other methods including fewer, additional, or alternative operations are possible consistent with this disclosure.

### Example Communications Devices

FIG. 12 depicts aspects of an example communications device 1200 configured for wireless communications. In some aspects, communications device 1200 is a user equipment, such as UE 104 described above with respect to FIG. 1 or UE 304 described with respect to FIG. 3.

The communications device 1200 includes a processing system 1205 coupled to a transceiver 1255 (e.g., a transmitter and/or a receiver). The transceiver 1255 is configured to transmit and receive signals for the communications device 1200 via an antenna 1260, such as the various signals as described herein. The processing system 1205 may be configured to perform processing functions for the communications device 1200, including processing signals received and/or to be transmitted by the communications device 1200.

The processing system 1205 includes one or more processors 1210 and a computer-readable medium/memory 1230. In various aspects, the one or more processors 1210 may be representative of the one or more processors 318 described with respect to FIG. 3. The one or more processors 1210 are coupled to a computer-readable medium/memory 1230 via a bus 1250. In some aspects, the computer-readable medium/memory 1230 may be representative of the one or more memories 320 described with respect to FIG. 3. The computer-readable medium/memory 1230 is a non-transitory computer-readable medium/memory. In certain aspects, the computer-readable medium/memory 1230 is configured to store instructions (e.g., computer-executable code), that when executed by the one or more processors 1210, cause the one or more processors 1210 to perform the method 1000 described with respect to FIG. 10, or any aspect related to it, including any operations described in relation to FIG. 10. Note that reference to a processor performing a function of communications device 1200 may include one or more processors performing that function of communications device 1200, such as in a distributed fashion.

In the depicted example, computer-readable medium/memory 1230 stores code (e.g., executable instructions), including code for obtaining 1235, code for communicating 1240, and code for sending 1245. Processing of the code 1235-1245 may enable and cause the communications device 1200 to perform the method 1000 described with respect to FIG. 10, or any aspect related to it. For instance, in some aspects, code for obtaining 1235 includes code for obtaining signaling that includes an indication of a plurality of transmission occasions associated with synchronization signaling, wherein: the synchronization signaling includes a first set of synchronization signals and a second set of synchronization signals, and the indication of the plurality of transmission occasions indicates that the first set of synchronization signals is arranged in time with a first periodicity and indicates that the second set of synchronization signals is arranged in time with a second periodicity different from the first periodicity. In some aspects, code for obtaining 1235 includes code for obtaining at least one synchronization signal of the synchronization signaling in at least one transmission occasion of the plurality of transmission occasions. In some aspects, code for communicating 1240 includes code for communicating based at least in part on the at least one synchronization signal.

The one or more processors 1210 include circuitry configured to implement (e.g., execute) the code stored in the computer-readable medium/memory 1230, including circuitry for obtaining 1215, circuitry for communicating 1220, and circuitry for sending 1225. Processing with circuitry 1215-1225 may enable and cause the communications device 1200 to perform the method 1000 described with respect to FIG. 10, or any aspect related to it. For instance, in some aspects, circuitry for obtaining 1215 includes circuitry for obtaining signaling that includes an indication of a plurality of transmission occasions associated with synchronization signaling, wherein: the synchronization signaling includes a first set of synchronization signals and a second set of synchronization signals, and the indication of the plurality of transmission occasions indicates that the first set of synchronization signals is arranged in time with a first periodicity and indicates that the second set of synchronization signals is arranged in time with a second periodicity different from the first periodicity. In some aspects, circuitry for obtaining 1215 includes circuitry for obtaining at least one synchronization signal of the synchronization signaling in at least one transmission occasion of the plurality of transmission occasions. In some aspects, circuitry for communicating 1220 includes circuitry for communicating based at least in part on the at least one synchronization signal.

More generally, means for communicating, transmitting, sending or outputting for transmission may include the one or more transceivers 324, one or more antenna 322 and/or processing system 316 of the UE 304 illustrated in FIG. 3, transceiver 1255 and/or antenna 1260 of the communications device 1200 in FIG. 12, and/or one or more processors 1210 of the communications device 1200 in FIG. 12. Means for communicating, receiving or obtaining may include the one or more transceivers 324, one or more antennas 322, and/or processing system 316 of the UE 304 illustrated in FIG. 3, transceiver 1255 and/or antenna 1260 of the communications device 1200 in FIG. 12, and/or one or more processors 1210 of the communications device 1200 in FIG. 12.

FIG. 13 depicts aspects of an example communications device configured for wireless communications. In some aspects, communications device 1300 is a network entity, such as BS 102 of FIG. 1, first network entity 300 or second network entity 302 of FIG. 3, or a disaggregated base station as discussed with respect to FIG. 2.

The communications device 1300 includes a processing system 1305 coupled to a transceiver 1355 (e.g., a transmitter and/or a receiver) and/or a network interface 1365. The transceiver 1355 is configured to transmit and receive signals for the communications device 1300 via an antenna 1360, such as the various signals as described herein. The network interface 1365 is configured to obtain and send signals for the communications device 1300 via communications link(s), such as a backhaul link, midhaul link, and/or fronthaul link as described herein, such as with respect to FIG. 2. The processing system 1305 may be configured to perform processing functions for the communications device 1300, including processing signals received and/or to be transmitted by the communications device 1300.

The processing system 1305 includes one or more processors 1310 and a computer-readable medium/memory 1330. In various aspects, one or more processors 1310 may be representative of the one or more processors 308, as described with respect to FIG. 3. The one or more processors 1310 are coupled to the computer-readable medium/memory 1330 via a bus 1350. In certain aspects, the computer-readable medium/memory 1330 is configured to store instructions (e.g., computer-executable code), including code 1335-1345, that when executed by the one or more processors 1310, cause the one or more processors 1310 to perform the method 1100 described with respect to FIG. 11, or any aspect related to it, including any operations described in relation to FIG. 11. The computer-readable medium/memory 1330 is a non-transitory computer-readable medium/memory. Note that reference to a processor of communications device 1300 performing a function may include one or more processors of communications device 1300 performing that function, such as in a distributed fashion.

In the depicted example, the computer-readable medium/memory 1330 stores code (e.g., executable instructions), including code for sending 1335, code for communicating 1340, and code for obtaining 1345. Processing of the code 1335-1345 may enable and cause the communications device 1300 to perform the method 1100 described with respect to FIG. 11, or any aspect related to it. For instance, in some aspects, code for sending 1335 includes code for sending signaling that includes an indication of a plurality of transmission occasions associated with synchronization signaling, wherein: the synchronization signaling includes a first set of synchronization signals and a second set of synchronization signals, and the indication of the plurality of transmission occasions indicates that the first set of synchronization signals is arranged in time with a first periodicity and indicates that the second set of synchronization signals is arranged in time with a second periodicity different from the first periodicity. In some aspects, code for sending 1335 includes code for sending at least one synchronization signal of the synchronization signaling in at least one transmission occasion of the plurality of transmission occasions. In some aspects, code for communicating 1340 includes code for communicating based at least in part on the at least one synchronization signal.

The one or more processors 1310 include circuitry configured to implement (e.g., execute) the code stored in the computer-readable medium/memory 1330, including circuitry for sending 1315, circuitry for communicating 1320, and circuitry for obtaining 1325. Processing with circuitry 1315-1325 may enable and cause the communications device 1300 to perform the method 1100 described with respect to FIG. 11, or any aspect related to it. For instance, in some aspects, circuitry for sending 1315 includes circuitry for sending signaling that includes an indication of a plurality of transmission occasions associated with synchronization signaling, wherein: the synchronization signaling includes a first set of synchronization signals and a second set of synchronization signals, and the indication of the plurality of transmission occasions indicates that the first set of synchronization signals is arranged in time with a first periodicity and indicates that the second set of synchronization signals is arranged in time with a second periodicity different from the first periodicity. In some aspects, circuitry for sending 1315 includes circuitry for sending at least one synchronization signal of the synchronization signaling in at least one transmission occasion of the plurality of transmission occasions. In some aspects, circuitry for communicating 1320 includes circuitry for communicating based at least in part on the at least one synchronization signal.

Various components of the communications device 1300 may provide means for performing the method 1100 described with respect to FIG. 11, or any aspect related to it. Means for communicating, transmitting, sending or outputting for transmission may include the one or more transceivers 312, one or more antennas 314, and/or processing system 306 of the first network entity 300 or the second network entity 302 illustrated in FIG. 3, transceiver 1355, antenna 1360, and/or network interface 1365 of the communications device 1300 in FIG. 13, and/or one or more processors 1310 of the communications device 1300 in FIG. 13. Means for communicating, receiving or obtaining may include the one or more transceivers 312, one or more antennas 314, and/or processing system 306 of the first network entity 300 or the second network entity 302 illustrated in FIG. 3, transceiver 1355, antenna 1360, and/or network interface 1365 of the communications device 1300 in FIG. 13, and/or one or more processors 1310 of the communications device 1300 in FIG. 13.

### Example Clauses

Implementation examples are described in the following numbered clauses:
Clause 1: A method for wireless communications by a UE comprising: obtaining signaling that includes an indication of a plurality of transmission occasions associated with synchronization signaling, wherein: the synchronization signaling includes a first set of synchronization signals and a second set of synchronization signals, and the indication of the plurality of transmission occasions indicates that the first set of synchronization signals is arranged in time with a first periodicity and indicates that the second set of synchronization signals is arranged in time with a second periodicity different from the first periodicity; obtaining at least one synchronization signal of the synchronization signaling in at least one transmission occasion of the plurality of transmission occasions; and communicating based at least in part on the at least one synchronization signal.
Clause 2: The method of Clause 1, wherein the second periodicity is less than the first periodicity.
Clause 3: The method of any one of Clauses 1-2, wherein the signaling further includes one or more of: an indication that the first set of synchronization signals includes on-demand synchronization signaling; or an indication that the second set of synchronization signals includes on-demand synchronization signaling.
Clause 4: The method of any one of Clauses 1-3, wherein: the signaling further includes: an indication of a first set of random access occasions associated with the first set of synchronization signals, and an indication of a second set of random access occasions associated with the second set of synchronization signals; and the method further comprises sending, in at least one random access occasion of the first set of random access occasions, a wake-up signal that requests transmission of the first set of synchronization signals.
Clause 5: The method of any one of Clauses 1-4, wherein: the signaling further includes an indication of a set of random access occasions associated with the first set of synchronization signals and the second set of synchronization signals; and the method further comprises sending, in at least one random access occasion of the set of random access occasions, a wake-up signal that requests transmission of the first set of synchronization signals.
Clause 6: The method of any one of Clauses 1-5, wherein the at least one synchronization signal includes an explicit indication of whether the at least one synchronization signal is part of (i) the first set of synchronization signals or (ii) the second set of synchronization signals.
Clause 7: The method of any one of Clauses 1-6, wherein the signaling further includes an indication of a SSB index mapping between a set of SSB indexes and the synchronization signaling, wherein the indication of the SSB index mapping indicates that the set of SSB indexes is partitioned into a first set of SSB indexes mapped to at least a first portion of the second set of synchronization signals and a second set of SSB indexes mapped to at least the second set of synchronization signals.
Clause 8: The method of Clause 7, wherein indication of the SSB index mapping indicates that the second set of SSB indexes is further mapped to a second portion of the second set of synchronization signals.
Clause 9: The method of Clause 7, wherein the SSB index mapping is based at least in part on one or more characteristics of the synchronization signaling.
Clause 10: The method of any one of Clauses 1-9, wherein: the signaling further includes an indication of an association between a set of random access occasions and the synchronization signaling; and the method further comprises sending a random access message in at least one random access occasion of the set of random access occasions, wherein the at least one random access occasion is associated with the at least one synchronization signal.
Clause 11: The method of Clause 10, wherein the indication of the association indicates that the set of random access occasions is partitioned into a first set of random access occasions associated with the first set of synchronization signals and a second set of random access occasions associated with the second set of synchronization signals.
Clause 12: The method of Clause 11, wherein the signaling further includes: an indication of a first set of random access parameters associated with the first set of synchronization signals; and an indication of a second set of random access parameters associated with the second set of synchronization signals.
Clause 13: The method of any one of Clauses 1-12, further comprising obtaining an indication that prediction of a first set of characteristics associated with the first set of synchronization signals is based on a second set of characteristics associated with the second set of synchronization signals; and communicating comprises communicating based at least in part on the prediction of the first set of characteristics associated with the first set of synchronization signals and the second set of characteristics associated with the second set of synchronization signals.
Clause 14: The method of any one of Clauses 1-13, wherein communicating comprises communicating based at least in part on the second set of characteristics associated with the second set of synchronization signals.
Clause 15: A method for wireless communications by a network node comprising: sending signaling that includes an indication of a plurality of transmission occasions associated with synchronization signaling, wherein: the synchronization signaling includes a first set of synchronization signals and a second set of synchronization signals, and the indication of the plurality of transmission occasions indicates that the first set of synchronization signals is arranged in time with a first periodicity and indicates that the second set of synchronization signals is arranged in time with a second periodicity different from the first periodicity; sending at least one synchronization signal of the synchronization signaling in at least one transmission occasion of the plurality of transmission occasions; and communicating based at least in part on the at least one synchronization signal.
Clause 16: The method of Clause 15, wherein the second periodicity is less than the first periodicity.
Clause 17: The method of any one of Clauses 15-16, wherein the signaling further includes one or more of: an indication that the first set of synchronization signals includes on-demand synchronization signaling; or an indication that the second set of synchronization signals includes on-demand synchronization signaling.
Clause 18: The method of any one of Clauses 15-17, wherein: the signaling further includes: an indication of a first set of random access occasions associated with the first set of synchronization signals, and an indication of a second set of random access occasions associated with the second set of synchronization signals; and the method further comprises obtaining, in at least one random access occasion of the first set of random access occasions, a wake-up signal that requests transmission of the first set of synchronization signals.
Clause 19: The method of any one of Clauses 15-18, wherein: the signaling further includes an indication of a set of random access occasions associated with the first set of synchronization signals and the second set of synchronization signals; and the method further comprises obtaining, in at least one random access occasion of the set of random access occasions, a wake-up signal that requests transmission of the first set of synchronization signals.
Clause 20: The method of any one of Clauses 15-19, wherein the at least one synchronization signal includes an explicit indication of whether the at least one synchronization signal is part of (i) the first set of synchronization signals or (ii) the second set of synchronization signals.
Clause 21: The method of any one of Clauses 15-20, wherein the signaling further includes an indication of a SSB index mapping between a set of SSB indexes and the synchronization signaling, wherein the indication of the SSB index mapping indicates that the set of SSB indexes is partitioned into a first set of SSB indexes mapped to at least a first portion of the second set of synchronization signals and a second set of SSB indexes mapped to at least the second set of synchronization signals.
Clause 22: The method of Clause 21, wherein indication of the SSB index mapping indicates that the second set of SSB indexes is further mapped to a second portion of the second set of synchronization signals.
Clause 23: The method of Clause 21, wherein the SSB index mapping is based at least in part on one or more characteristics of the synchronization signaling.
Clause 24: The method of any one of Clauses 15-23, wherein: the signaling further includes an indication of an association between a set of random access occasions and the synchronization signaling; and the method further comprises obtaining a random access message in at least one random access occasion of the set of random access occasions, wherein the at least one random access occasion is associated with the at least one synchronization signal.
Clause 25: The method of Clause 24, wherein the indication of the association indicates that the set of random access occasions is partitioned into a first set of random access occasions associated with the first set of synchronization signals and a second set of random access occasions associated with the second set of synchronization signals.
Clause 26: The method of Clause 25, wherein the signaling further includes: an indication of a first set of random access parameters associated with the first set of synchronization signals; and an indication of a second set of random access parameters associated with the second set of synchronization signals.
Clause 27: The method of any one of Clauses 15-26, wherein: the method further comprises sending an indication that prediction of a first set of characteristics associated with the first set of synchronization signals is based on a second set of characteristics associated with the second set of synchronization signals; and communicating comprises communicating based at least in part on the prediction of the first set of characteristics associated with the first set of synchronization signals and the second set of characteristics associated with the second set of synchronization signals.
Clause 28: The method of any one of Clauses 15-27, wherein communicating comprises communicating based at least in part on the second set of characteristics associated with the second set of synchronization signals.
Clause 29: One or more apparatuses, comprising: one or more memories comprising executable instructions; and one or more processors configured to execute the executable instructions and cause the one or more apparatuses to perform a method in accordance with any one of Clauses 1-28.
Clause 30: One or more apparatuses configured for wireless communications, comprising: one or more memories; and one or more processors, coupled to the one or more memories, configured to cause the one or more apparatuses to perform a method in accordance with any one of Clauses 1-28.
Clause 31: One or more apparatuses configured for wireless communications, comprising: one or more memories; and one or more processors, coupled to the one or more memories, configured to perform a method in accordance with any one of Clauses 1-28.
Clause 32: One or more apparatuses, comprising means for performing a method in accordance with any one of Clauses 1-28.
Clause 33: One or more non-transitory computer-readable media comprising executable instructions that, when executed by one or more processors of one or more apparatuses, cause the one or more apparatuses to perform a method in accordance with any one of Clauses 1-28.
Clause 34: One or more computer program products embodied on one or more computer-readable storage media comprising code for performing a method in accordance with any one of Clauses 1-28.
Clause 35: One or more apparatuses configured for wireless communications, comprising: a processing system that includes one or more processors and one or more memories coupled with the one or more processors, the processing system configured to cause the one or more apparatuses to perform a method in accordance with any one of Clauses 1-28.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of′ a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus for wireless communications, comprising a processing system that includes one or more processors and one or more memories coupled with the one or more processors, the processing system configured to cause a user equipment (UE) to:
obtain signaling that includes an indication of a plurality of transmission occasions associated with synchronization signaling, wherein:
the synchronization signaling includes a first set of synchronization signals and a second set of synchronization signals, and
the indication of the plurality of transmission occasions indicates that the first set of synchronization signals is arranged in time with a first periodicity and indicates that the second set of synchronization signals is arranged in time with a second periodicity different from the first periodicity;
obtain at least one synchronization signal of the synchronization signaling in at least one transmission occasion of the plurality of transmission occasions; and
communicate based at least in part on the at least one synchronization signal.

2. The apparatus of claim 1, wherein:
the second periodicity is less than the first periodicity; and
the synchronization signaling is arranged in a carrier associated with a cell.

3. The apparatus of claim 1, wherein the signaling further includes one or more of:
an indication that the first set of synchronization signals includes on-demand synchronization signaling; or
an indication that the second set of synchronization signals includes on-demand synchronization signaling.

4. The apparatus of claim 1, wherein:
the signaling further includes:
an indication of a first set of random access occasions associated with the first set of synchronization signals, and
an indication of a second set of random access occasions associated with the second set of synchronization signals; and
the processing system is configured to cause the UE to send, in at least one random access occasion of the first set of random access occasions, a wake-up signal that requests transmission of the first set of synchronization signals.

5. The apparatus of claim 1, wherein:
the signaling further includes an indication of a set of random access occasions associated with the first set of synchronization signals and the second set of synchronization signals; and
the processing system is configured to cause the UE to send, in at least one random access occasion of the set of random access occasions, a wake-up signal that requests transmission of the first set of synchronization signals.

6. The apparatus of claim 1, wherein the at least one synchronization signal includes an explicit indication of whether the at least one synchronization signal is part of (i) the first set of synchronization signals or (ii) the second set of synchronization signals.

7. The apparatus of claim 1, wherein the signaling further includes an indication of a synchronization signal block (SSB) index mapping between a set of SSB indexes and the synchronization signaling, wherein the indication of the SSB index mapping indicates that the set of SSB indexes is partitioned into a first set of SSB indexes mapped to at least a first portion of the second set of synchronization signals and a second set of SSB indexes mapped to at least the second set of synchronization signals.

8. The apparatus of claim 7, wherein indication of the SSB index mapping indicates that the second set of SSB indexes is further mapped to a second portion of the second set of synchronization signals.

9. The apparatus of claim 7, wherein the SSB index mapping is based at least in part on one or more characteristics of the synchronization signaling.

10. The apparatus of claim 1, wherein:
the signaling further includes an indication of an association between a set of random access occasions and the synchronization signaling; and
the processing system is configured to cause the UE to send a random access message in at least one random access occasion of the set of random access occasions,
wherein the at least one random access occasion is associated with the at least one synchronization signal.

11. The apparatus of claim 10, wherein the indication of the association indicates that the set of random access occasions is partitioned into a first set of random access occasions associated with the first set of synchronization signals and a second set of random access occasions associated with the second set of synchronization signals.

12. The apparatus of claim 11, wherein the signaling further includes:
an indication of a first set of random access parameters associated with the first set of synchronization signals; and
an indication of a second set of random access parameters associated with the second set of synchronization signals.

13. The apparatus of claim 1, wherein:
the processing system is configured to cause the UE to obtain an indication that prediction of a first set of characteristics associated with the first set of synchronization signals is based on a second set of characteristics associated with the second set of synchronization signals; and
to cause the UE to communicate, the processing system is configured to cause the UE to communicate based at least in part on the prediction of the first set of characteristics associated with the first set of synchronization signals and the second set of characteristics associated with the second set of synchronization signals.

14. The apparatus of claim 1, wherein:
the processing system is configured to cause the UE to obtain an indication that prediction of a first set of characteristics associated with the first set of synchronization signals is based on a second set of characteristics associated with the second set of synchronization signals; and
to cause the UE to communicate, the processing system is configured to cause the UE to communicate based at least in part on the second set of characteristics associated with the second set of synchronization signals.

15. An apparatus for wireless communications, comprising a processing system that includes one or more processors and one or more memories coupled with the one or more processors, the processing system configured to cause a network node to:
send signaling that includes an indication of a plurality of transmission occasions associated with synchronization signaling, wherein:
the synchronization signaling includes a first set of synchronization signals and a second set of synchronization signals, and
the indication of the plurality of transmission occasions indicates that the first set of synchronization signals is arranged in time with a first periodicity and indicates that the second set of synchronization signals is arranged in time with a second periodicity different from the first periodicity;
send at least one synchronization signal of the synchronization signaling in at least one transmission occasion of the plurality of transmission occasions; and
communicate based at least in part on the at least one synchronization signal.

16. The apparatus of claim 15, wherein:
the second periodicity is less than the first periodicity; and
the synchronization signaling is arranged in a carrier associated with a cell.

17. The apparatus of claim 15, wherein the signaling further includes one or more of:
an indication that the first set of synchronization signals includes on-demand synchronization signaling; or
an indication that the second set of synchronization signals includes on-demand synchronization signaling.

18. The apparatus of claim 15, wherein the at least one synchronization signal includes an explicit indication of whether the at least one synchronization signal is part of (i) the first set of synchronization signals or (ii) the second set of synchronization signals.

19. The apparatus of claim 15, wherein the signaling further includes an indication of a synchronization signal block (SSB) index mapping between a set of SSB indexes and the synchronization signaling, wherein the indication of the SSB index mapping indicates that the set of SSB indexes is partitioned into a first set of SSB indexes mapped to at least a first portion of the second set of synchronization signals and a second set of SSB indexes mapped to at least the second set of synchronization signals.

20. A method for wireless communications by a user equipment (UE), comprising:
obtaining signaling that includes an indication of a plurality of transmission occasions associated with synchronization signaling, wherein:
the synchronization signaling includes a first set of synchronization signals and a second set of synchronization signals, and
the indication of the plurality of transmission occasions indicates that the first set of synchronization signals is arranged in time with a first periodicity and indicates that the second set of synchronization signals is arranged in time with a second periodicity different from the first periodicity;
obtaining at least one synchronization signal of the synchronization signaling in at least one transmission occasion of the plurality of transmission occasions; and
communicating based at least in part on the at least one synchronization signal.
